(19) United States
(12) Patent Application Publication
(10) Pub. No.: US 2003/0155667 A1
(43) Pub. Date: Aug. 21, 2003

(54) Method for making or adding structures to an article

(76) Inventors: Robert J Devoe, Oakdale, MN (US); Brook F Duerr, Lake Elmo, MN (US); Patrick R Fleming, Lake Elmo, MN (US); Harvey W Kalweit, Burnsville, MN (US)

Correspondence Address: Lucy C Weiss, Office of Intellectual Property Counsel, 3M Innovative Properties Company, Post Office Box 33427, St Paul, MN, 55133-3427, US

(21) Appl. No.: 10/297,958

(22) PCT Filed: Jun. 14, 2001
(86) PCT No.: PCT/US01/40988

(51) Int. Cl. B29D 11/00; B29C 35/08

(52) U.S. Cl. 264/1.27; 264/482; 264/494; 264/1.31; 264/16

(57) ABSTRACT

A method for making a structure including applying a multiphoton-curable composition to a molded article, wherein the composition comprises a curable species and a multiphoton photoinitiator system, and at least partially curing the multiphoton-curable composition to form a structure on the article.

### RELATED APPLICATIONS

This application claims priority from U.S. Provisional Application Nos. 60/211,588 and 60/211,706, both of which were filed Jun. 15, 2000 and are hereby incorporated by reference.

### TECHNICAL FIELD

This invention relates to a method of making or adding structures to an article with a multiphoton curing process.

### BACKGROUND

Molding techniques such as injection molding, compression molding, embossing, extrusion embossing, and polymerizing within a mold may be used to fabricate a polymeric article. To make a metal article, techniques such as stamping, casting and machining may be used, while etching, sintering, and grinding are appropriate for use in forming a ceramic article. These macroscopic fabrication techniques may be used to form an article or to impart a structure to the surface of an article. Relatively large three-dimensional parts can be made in a separate molding step, assembled, and attached to the surface of the article, but this technique is not useful for the fabrication and assembly of microscopic parts. For example, certain categories of microstructures, such as undercuts, generally cannot be molded on the surface of an article. Furthermore, it may be difficult and not feasible to mold microstructures onto the surface of an article if further conventional processing of the microstructures can damage the article.

In certain applications it may be desirable to control stress (amount and direction) in a cured composition by the manner in which the curing process is conducted. For example, if the surface of the molded article includes a feature such as a depression or groove, it may become necessary to form a structure within the feature or along a sidewall of the feature. Some structures may be added to the feature by placing a curable composition into the feature and curing it with light. In a conventional photocuring process, the curable composition absorbs a significant portion of the curing radiation, so the surface receives the greatest light intensity. As a result, the surface of the curable composition cures first, and then the remainder of the composition cures gradually from the surface of the curable composition to the full depth of the feature. This can make the cure of thick layers quite difficult. In some cases, it is desirable to cure the bottom layers of the curable composition first to reduce stress on the surface or in the feature of the molded article. Curing up from the bottom requires that multiple layers of the curable composition be applied in the feature, with each layer being cured before the next layer is applied. This multiple step process is time consuming and inefficient.

### SUMMARY

If an article is fabricated by conventional techniques, the invention provides a method by which one or a few small, key components can be added in situ with a multiphoton curing process. Whereas single-photon absorption scales linearly with the intensity of the incident radiation, two-photon absorption scales quadratically. Higher-order absorptions scale with a related higher power of incident intensity. As a result, it is possible to perform multiphoton curing processes with three-dimensional spatial resolution. Also, because multiphoton processes involve the simultaneous absorption of two or more photons, the absorbing chromophore is excited with a number of photons whose total energy equals the energy of an excited state of a multiphoton photosensitizer, even though each photon individually has insufficient energy to excite the chromophore. The exciting light is not attenuated by single-photon absorption within a curable matrix or material, so it is possible to selectively excite molecules at a greater depth within a material than would be possible via single-photon excitation.

In one embodiment, the invention is a method for making a structure, including: applying a multiphoton-curable composition to a molded article, wherein the composition includes a curable species and a multiphoton photoinitiator system; at least partially curing the multiphoton-curable composition to form a structure on the article.

In a second embodiment, the invention is a method of adding a structure to an article, wherein the article has a surface with at least one microscopic feature, the method including: applying a multiphoton-curable composition to the feature, wherein the composition includes: a curable species, and a multiphoton photoinitiator system including a multiphoton photosensitizer and an electron acceptor; at least partially curing the multiphoton-curable composition to form a structure.

In a third embodiment, the invention is a method of adding a structure to an optical fiber, the method including: applying a multiphoton-curable composition to the optical fiber, wherein the composition includes: a curable species, and a multiphoton photoinitiator system including a multiphoton photosensitizer and an electron acceptor; at least partially curing the multiphoton-curable composition to form a structure.

In a fourth embodiment, the invention is a method for making a diffraction grating on a substrate, including applying a multiphoton-curable composition on the surface, wherein the composition includes: a curable species, and a multiphoton photoinitiator system including a multiphoton photosensitizer and an electron acceptor; and at least partially curing the multiphoton-curable composition to form a diffraction grating on the surface.

In a fifth embodiment, the invention is a method of filling a cavity with a multiphoton cured material including providing a multiphoton curable composition, wherein the composition includes a curable species and a multiphoton photoinitiator system, said multiphoton photoinitiator system including a multiphoton photosensitizer and an electron acceptor; providing a substrate with a cavity; exposing the multiphoton curable composition to a light source sufficient to cause multiphoton absorption.

In a sixth embodiment, the invention is a method of repairing a tooth, including: applying a multiphoton-curable composition to the tooth, wherein the composition includes: a curable species, and a multiphoton photoinitiator system including a multiphoton photosensitizer and an electron acceptor; at least partially curing the multiphoton-curable composition.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a schematic representation of a multiphoton curing system.

FIG. 2 is a cross sectional view of a cavity in an article filled with a multiphoton curable material.

FIG. 3A is an end view of a flow control device in a channel in an article.

FIG. 3B is an overhead view of the flow control device of FIG. 3A.

FIG. 3C is a cross-sectional view of a portion of the flow control device of FIG. 3A.

FIG. 4 is a cross-sectional view of a diffraction grating.

FIG. 5 is a cross-sectional view of an undercut region in a channel in an article.

FIG. 6A is an end view of a flow control device in a channel in an article.

FIG. 6B is an overhead view of the flow control device of FIG. 6A.

FIG. 6C is a cross-sectional view of a portion of the flow control device of FIG. 3A.

Like reference symbols in the various drawings indicate like elements.

### DETAILED DESCRIPTION

The present invention provides a method of making or adding a structure to article. The method includes coating a multiphoton-curable composition on a surface of the partially-completed article, and curing the multiphoton-curable composition to form a structure on the surface.

Exposure System and Its Use

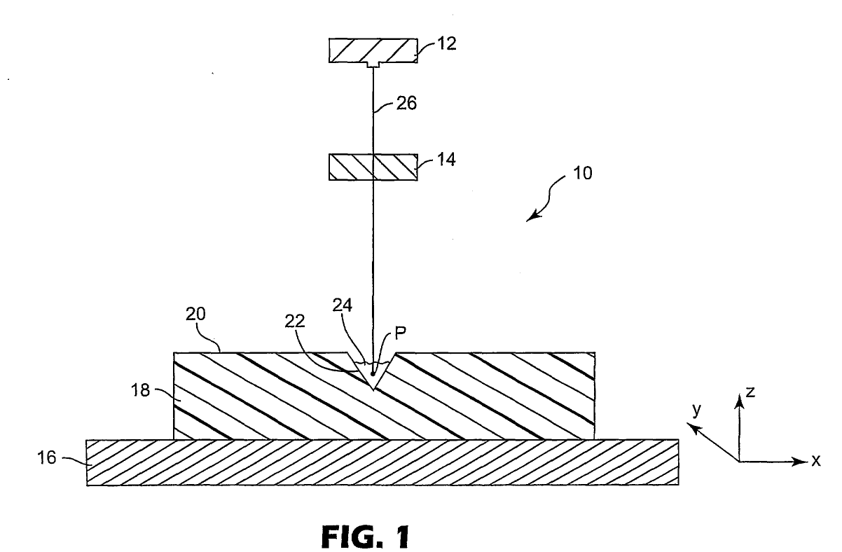

Referring to FIG. 1, an optical system 10 for use in the invention includes a light source 12, an optical element 14, and a moveable stage 16. The stage 16 is preferably moveable in three dimensions. A partially completed article 18 mounted on the stage 16 includes a surface 20 and an optional surface feature 22. A multiphoton-curable composition 24 is applied on the surface 20 or in the feature 22. The light 26 from the light source 12 is then focused to a point P within the volume of the curable composition 24 to control the three-dimensional spatial distribution of light intensity within the composition to at least partially cure the composition 24.

Generally, light from a pulsed laser can be passed through a focusing optical train to focus the beam within the volume of the curable composition 24. Using the stage 16, or by moving the light source 12 (for example, moving a laser beam using galvo-mirrors), the focal point P can be scanned or translated in a three-dimensional pattern that corresponds to a desired shape. The cured or partially cured portion of the curable composition 24 then creates a three-dimensional image of a desired shape.

The light source 12 in the system 10 may be any light source that produces multiphoton curing radiation—radiation capable of initiating a multiphoton curing process. Suitable sources include, for example, femtosecond near-infrared titanium sapphire oscillators (for example, those available from Coherent under the trade designation MIRA OPTIMA 900-F) pumped by an argon ion laser (for example, those available from Coherent under the trade designation INNOVA). This laser, operating at 76 MHz, has a pulse width of less than 200 femtoseconds, is tunable between 700 and 980 nm, and has average power up to 1.4 Watts (for example, a Spectra-Physics, Inc., (1335 Terra Bella Avenue, Mountain View, Calif. 94043 USA) “Mai Tai” model, operated at a wavelength λ=800 nm, a repetition frequency of 80 MHz, and a pulse width of about 100 femtoseconds (1×10⁻¹³ sec), with a power level up to 1 Watt).

However, in practice, any light source that provides sufficient intensity (to effect multiphoton absorption) at a wavelength appropriate for the photosensitizer (used in the photoreactive composition) can be utilized. Such wavelengths can generally be in the range of about 300 to about 1500 nm; preferably, from about 600 to about 1100 nm; more preferably, from about 750 to about 850 nm. Peak intensities can generally be from about 10⁶ W/cm². The upper limit on pulse fluence is generally dictated by the ablation threshold of the photoreactive composition. For example, Q-switched Nd:YAG lasers (for example, those available from Spectra-Physics under the trade designation QUANTA-RAY PRO), visible wavelength dye lasers (for example, those available from Spectra-Physics under the trade designation SIRAH pumped by a Spectra-Physics Quanta-Ray PRO), and Q-switched diode pumped lasers (for example, those available from Spectra-Physics under the trade designation FCBAR) can also be utilized. Preferred light sources are near infrared pulsed lasers having a pulse length less than about 10⁻⁸ second (more preferably, less than about 10⁻⁹ second; most preferably, less than about 10⁻¹¹ second). Other pulse lengths can be used as long as the peak intensity and ablation threshold criteria above are met.

Optical elements 14 useful in the system 10 include, for example, refractive optical elements (for example, lenses), reflective optical elements (for example, retroreflectors or focusing mirrors), diffractive optical elements (for example, gratings, phase masks, and holograms), polarizing optical elements (for example, linear polarizers and waveplates), diffusers, pockels cells, wave guides, and the like. Such optical elements are useful for focusing, beam delivery, beam/mode shaping, pulse shaping, and pulse timing. Generally, combinations of optical elements can be utilized, and other appropriate combinations will be recognized by those skilled in the art. It is often desirable to use optics with large numerical aperture (NA) to provide highly-focused light. However, any combination of optical elements that provides a desired intensity profile (and spatial placement thereof) can be utilized. For example, the exposure system can include a scanning confocal microscope (for example, those available from BioRad under the trade designation MRC600) equipped with a 0.75 NA objective (such as, for example, those available from Zeiss under the trade designation 20×FLUAR).

Exposure times generally depend upon the type of exposure system used to cause image formation (and its accompanying variables such as numerical aperture, geometry of light intensity spatial distribution, the peak light intensity during the laser pulse (higher intensity and shorter pulse duration roughly correspond to peak light intensity)), as well as upon the nature of the multiphoton curable composition exposed. Generally, higher peak light intensity in the regions of focus allows shorter exposure times, everything else being equal. Linear imaging or “writing” speeds generally can be about 5 to 100,000 microns/second using a laser pulse duration of about 10⁻⁸ to 10⁻¹⁵ second (preferably, about 10⁻¹¹ to 10⁻¹⁴ second) and about 10² to 10⁹ pulses per second (preferably, about 10³ to 10⁸ pulses per second).

The multiphoton curable radiation 26 induces a reaction in the curable composition that produces a material having solubility characteristics different from those of the unexposed curable composition. The resulting pattern of cured material may then be developed by removing either the exposed or the unexposed regions with an appropriate solvent. Cured, complex, seamless three-dimensional structures can be prepared in this manner

The resulting structures may have any suitable size and shape, but the method of the invention is particularly well suited for adding a microstructure to a microstructured surface of an article. The structures may be formed on the surface of the article, or within or on a feature of the surface. Where such feature(s) exist on the surface of an article, for example, continuous or discontinuous patterns of depressions, protrusions, posts, or channels, the structures may be formed in the feature(s). The feature(s) may be microscopic, where the term “microscopic” refers to features of small enough dimension so as to require an optic aid to the naked eye when viewed from any plane of view to determine its shape. One criterion is found in Modem Optic Engineering by W. J. Smith, McGraw-Hill, 1966, pages 104-105 whereby visual acuity, “ . . . is defined and measured in terms of the angular size of the smallest character that can be recognized.” Normal visual acuity is considered to be when the smallest recognizable letter subtends an angular height of 5 minutes of arc on the retina. At typical working distance of 250 mm (10 inches), this yields a lateral dimension of 0.36 mm (0.0145 inch) for this object. As used herein, the term “microstructure” means the configuration of features wherein at least 2 dimensions of the features are microscopic.

Referring to FIG. 2, in a preferred embodiment, a multiphoton curable material 124 can be placed in a feature 122 in a surface 120 of an article 118. The feature can be a cavity such as a cavity, depression or groove. The multiphoton curable radiation 126 may be focused at any point P within the volume of the material to cure the material. With the depth control possible in multiphoton curing, a curable composition can be easily cured from the bottom 123 of the feature 124 up, from the middle out, from the sidewall 125 in, or in whatever pattern is best for a particular application. For example, if a multiphoton curable material is placed in a cavity in a tooth, the curable material may be cured and hardened to form a dental filling. In such a dental filling, curing at all the surfaces first, and working toward the top center could provide a strong stress-free filling.

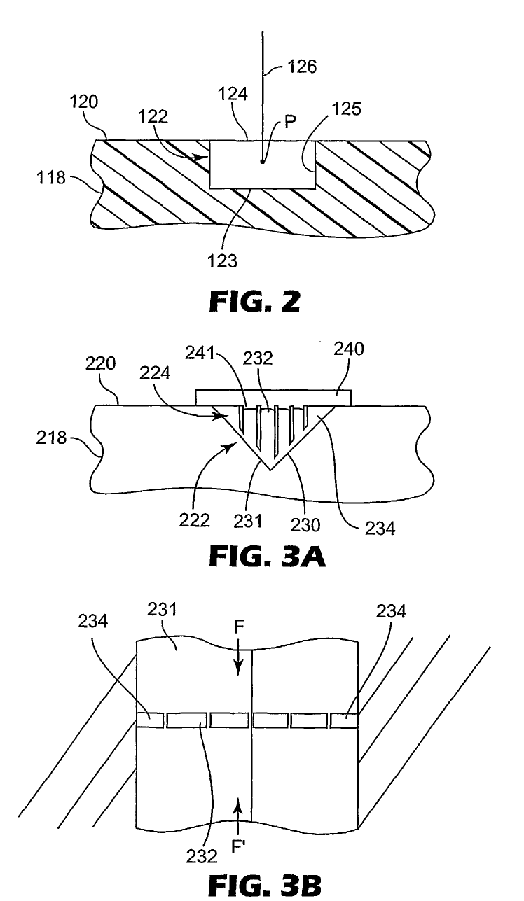

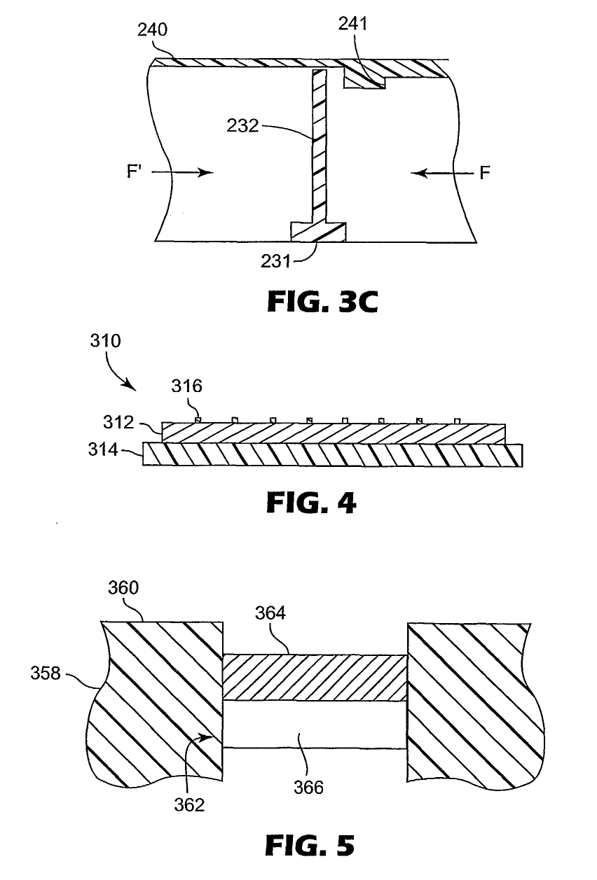

Referring to FIGS. 3A-3C, a curable material 224 can be cured in a specific pattern to form a check valve-like flow control structure in a channel 222 in a surface 220 of an article 218. The valve 230 includes a plurality of flexible extension regions 232 that extend upward from the bottom 231 of the channel 222. The regions 232 bend to allow fluid flow in a first direction indicated by an arrow F. Side buttresses 234 support an optional cover 240 (not shown in FIG. 3B). If the fluid flow moves in a direction F′, a stop bar 241 in the cover 240 limits the bending of the extension regions 232 to limit and/or stop flow in the direction F′.

Referring to FIG. 4, a multiphoton curable composition may be applied to an aluminized mirrored layer 312 on a silicon wafer 314. The multiphoton curable composition may then be cured in a stripe-like pattern to form a series of closely spaced lines 316. The lines of cured material break the surface of the mirrored layer 312 into reflective strips interrupted by the lines 316, forming a diffraction grating 310. Thus, a diffraction grating can be added to an already-fabricated mirror with little additional processing. No aluminum etching is required, and the curing process does not damage or oxidize the mirrored surface. The grating construction may be used, for example, as an oscillating MEMS mirror grating in a spectrophotometer.

Referring to FIG. 5, a multiphoton curable composition may be applied to a channel 362 in a surface 360 of an article 358. The curable composition may be cured to form a beam 364 in the channel 362, which leaves an undercut region 366 for fluid flow.

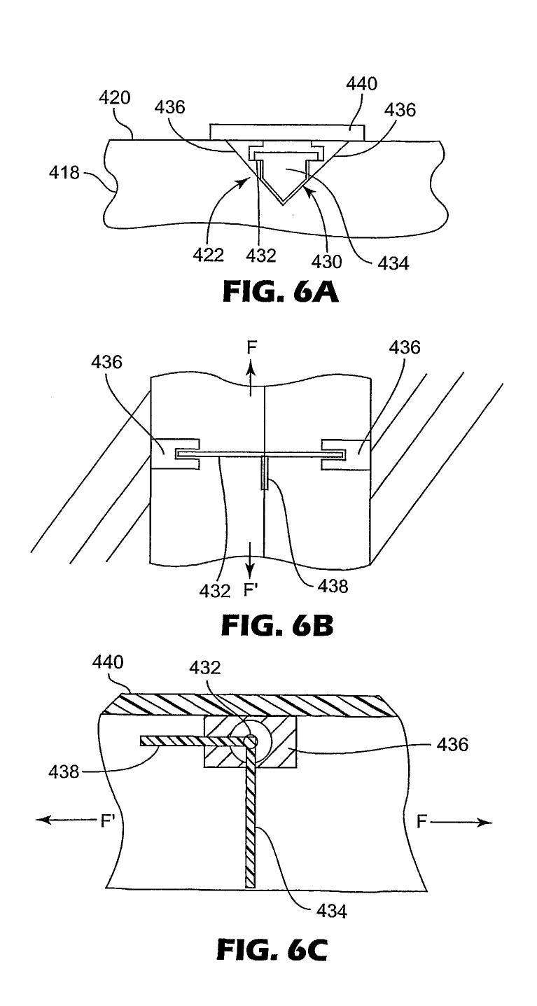

Referring to FIGS. 6A-6C, the inventive method may also be used to fabricate movable parts on a molded article. In FIGS. 6A-6C, multiphoton curable material may be applied in a channel 422 in a surface 420 of an article 418. The material may be cured to form a flapper-like flow control valve 430, which includes a central pivoting bar 432 and a flap 434. The valve 430 pivots about the longitudinal axis of the bar 432 in retaining structures 436. When fluid flow in the channel 422 moves in a direction F, the flap 434 allows substantially free fluid movement. However, if the flow moves in a direction F′, a stopper bar 438 contacts a cover 440 (not shown in FIG. 6B) and moves the flap 434 into a position to restrict fluid flow.

Examples of other parts that may be fabricated by the method of the present invention include a micropump, wherein one or more valves can be added with an multiphoton curing process; an accelerometer, wherein a cantilevered beam can be added; and a channel device, wherein the top of the channel can be added. Examples of parts that can be attached to the main body of a partially completed molded article include flapper valves, membranes, springs, bridges, cantilevers, flexures, covers, and caps. Examples of parts that can be totally detached from the body of a partially-completed article include balls for ball valves, spheres, gears, hinges, and spinners. Thus, it is sometimes desirable that a part fabricated according to the method of the invention adhere well to the main body and it is sometimes desirable that the part release from the main body.

In a preferred embodiment of the invention, a method of adding a structure can be performed on an optical fiber to add an optical device such as a lens, prism, diffuser, or diffractive element.

The multiphoton curable compositions that may be used to form the above-described structures include curable or non-curable species and a multiphoton photoinitiator system. The multiphoton photoinitiator system includes a multiphoton photosensitizer, an electron acceptor, and an optional electron donor.

Compositions of the invention can include curable species and optionally non-curable species.

Curable species include addition-polymerizable monomers and oligomers and addition-crosslinkable polymers (such as free-radically polymerizable or crosslinkable ethylenically-unsaturated species including, for example, acrylates, methacrylates, and certain vinyl compounds such as styrenes), as well as cationically-polymerizable monomers and oligomers and cationically-crosslinkable polymers (including, for example, epoxies, vinyl ethers, cyanate esters, etc.), and the like, and mixtures thereof.

Suitable ethylenically-unsaturated species are described, for example, in U.S. Pat. No. 5,545,676, and include mono-, di-, and poly-acrylates and methacrylates (for example, methyl acrylate, methyl methacrylate, ethyl acrylate, isopropyl methacrylate, n-hexyl acrylate, stearyl acrylate, allyl acrylate, glycerol diacrylate, glycerol triacrylate, ethyleneglycol diacrylate, diethyleneglycol diacrylate, triethyleneglycol dimethacrylate, 1,3-propanediol diacrylate, 1,3-propanediol dimethacrylate, trimethylolpropane triacrylate, 1,2,4-butanetriol trimethacrylate, 1,4-cyclohexanediol diacrylate, pentaerythritol triacrylate, pentaerythritol tetraacrylate, pentaerythritol tetramethacrylate, sorbitol hexacrylate, bis[1-(2-acryloxy)]-p-ethoxyphenyldimethylmethane, bis[1-(3-acryloxy-2-hydroxy)]-p-propoxyphenyldimethylmethane, trishydroxyethyl-isocyanurate trimethacrylate, the bis-acrylates and bis-methacrylates of polyethylene glycols of molecular weight about 200-500, copolymerizable mixtures of acrylated monomers such as those described in U.S. Pat. No. 4,652,274, and acrylated oligomers such as those described in U.S. Pat. No. 4,642,126); unsaturated amides (for example, methylene bis-acrylamide, methylene bis-methacrylamide, 1,6-hexamethylene bis-acrylamide, diethylene triamine tris-acrylamide and beta-methacrylaminoethyl methacrylate); vinyl compounds (for example, styrene, diallyl phthalate, divinyl succinate, divinyl adipate, and divinyl phthalate); and the like; and mixtures thereof.

Suitable reactive polymers include polymers with pendant (meth)acrylate groups, for example, having from 1 to about 50 (meth)acrylate groups per polymer chain. Examples of such polymers include aromatic acid (meth)acrylate half ester resins such as those available under the trade designation SARBOX from Sartomer (for example, SARBOX 400, 401, 402, 404, and 405). Other useful reactive polymers curable by free radical chemistry include those polymers that have a hydrocarbyl backbone and pendant peptide groups with free-radically polymerizable functionality attached thereto, such as those described in U.S. Pat. No. 5,235,015. Mixtures of two or more monomers, oligomers, and/or reactive polymers can be used if desired. Preferred ethylenically-unsaturated species include acrylates, aromatic acid (meth)acrylate half ester resins, and polymers that have a hydrocarbyl backbone and pendant peptide groups with free-radically polymerizable functionality attached thereto.

Suitable cationically-reactive species are described, for example, in U.S. Pat. Nos. 5,998,495 and 6,025,406 and include epoxy resins. Such materials, broadly called epoxides, include monomeric epoxy compounds and epoxides of the polymeric type and can be aliphatic, alicyclic, aromatic, or heterocyclic. These materials generally have, on the average, at least 1 polymerizable epoxy group per molecule (preferably, at least about 1.5 and, more preferably, at least about 2). The polymeric epoxides include linear polymers having terminal epoxy groups (for example, a diglycidyl ether of a polyoxyalkylene glycol), polymers having skeletal oxirane units (for example, polybutadiene polyepoxide), and polymers having pendant epoxy groups (for example, a glycidyl methacrylate polymer or copolymer). The epoxides can be pure compounds or can be mixtures of compounds containing one, two, or more epoxy groups per molecule. These epoxy-containing materials can vary greatly in the nature of their backbone and substituent groups. For example, the backbone can be of any type and substituent groups thereon can be any group that does not substantially interfere with cationic cure at room temperature. Illustrative of permissible substituent groups include halogens, ester groups, ethers, sulfonate groups, siloxane groups, nitro groups, phosphate groups, and the like. The molecular weight of the epoxy-containing materials can vary from about 58 to about 100,000 or more.

Useful epoxy-containing materials include those which contain cyclohexene oxide groups such as epoxycyclohexanecarboxylates, typified by 3,4-epoxycyclohexylmethyl-3,4-epoxycyclohexanecarboxylate, 3,4-epoxy-2-methylcyclohexylmethyl-3,4-epoxy-2-methylcyclohexane carboxylate, and bis(3,4-epoxy-6-methylcyclohexylmethyl) adipate. A more detailed list of useful epoxides of this nature is set forth in U.S. Pat. No. 3,117,099.

Other epoxy-containing materials that are useful include glycidyl ether monomers of the formula

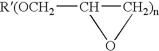

where R′ is alkyl or aryl and n is an integer of 1 to 6. Examples are glycidyl ethers of polyhydric phenols obtained by reacting a polyhydric phenol with an excess of a chlorohydrin such as epichlorohydrin (for example, the diglycidyl ether of 2,2-bis-(2,3-epoxypropoxyphenol)-propane). Additional examples of epoxides of this type are described in U.S. Pat. No. 3,018,262, and in Handbook of Epoxy Resins, Lee and Neville, McGraw-Hill Book Co., New York (1967).

Numerous commercially available epoxy resins can also be utilized. In particular, epoxides that are readily available include octadecylene oxide, epichlorohydrin, styrene oxide, vinyl cyclohexene oxide, glycidol, glycidylmethacrylate, diglycidyl ethers of Bisphenol A (for example, those available under the trade designations EPON 828, EPON 825, EPON 1004, and EPON 1010 from Resolution Performance Products, formerly Shell Chemical Co., as well as those available under the trade designations DER 331, DER 332, and DER 334 from Dow Chemical Co.), vinylcyclohexene dioxide (for example, the compounds available under the trade designations ERL 4206 from Union Carbide Corp.), 3,4-epoxycyclohexylmethyl-3,4-epoxycyclohexene carboxylate (for example, the compounds available under the trade designations ERL 4221, Cyracure UVR 6110 or UVR 6105 from Union Carbide Corp.), 3,4-epoxy-6-methylcyclohexylmethyl-3,4-epoxy-6-methyl-cyclohexene carboxylate (for example, the compounds available under the trade designation ERL 4201 from Union Carbide Corp.), bis(3,4-epoxy-6-methylcyclohexylmethyl) adipate (for example, the compounds available under the trade designation ERL 4289 from Union Carbide Corp.), bis(2,3-epoxycyclopentyl) ether (for example, the compounds available under the trade designation ERL 0400 from Union Carbide Corp.), aliphatic epoxy modified from polypropylene glycol (for example, those available under the trade designations ERL 4050 and ERL 4052 from Union Carbide Corp.), dipentene dioxide (for example, the compounds available under the trade designation ERL 4269 from Union Carbide Corp.), epoxidized polybutadiene (for example, the compounds available under the trade designations Oxiron 2001 from FMC Corp.), silicone resin containing epoxy functionality, flame retardant epoxy resins (for example, those available under the trade designation DER 580, a brominated bisphenol type epoxy resin available from Dow Chemical Co.), 1,4-butanediol diglycidyl ether of phenolformaldehyde novolak (for example, those available under the trade designations DEN 431 and DEN 438 from Dow Chemical Co.), resorcinol diglycidyl ether (for example, the compounds available under the trade designation KOPOXITE from Koppers Company, Inc.), bis(3,4-epoxycyclohexyl)adipate (for example, those available under the trade designations ERL 4299 or UVR 6128, from Union Carbide Corp.), 2-(3,4-epoxycyclohexyl-5,5-spiro-3,4-epoxy) cyclohexane-meta-dioxane (for example, the compounds available under the trade designation ERL-4234 from Union Carbide Corp.), vinylcyclohexene monoxide 1,2-epoxyhexadecane (for example, the compounds available under the trade designation UVR-6216 from Union Carbide Corp.), alkyl glycidyl ethers such as alkyl C₈-C₁₀ glycidyl ether (for example, those available under the trade designation HELOXY MODIFIER 7 from Resolution Performance Products), alkyl C₁₂-C₁₄ glycidyl ether (for example, those available under the trade designation HELOXY MODIFIER 8 from Resolution Performance Products), butyl glycidyl ether (for example, those available under the trade designation HELOXY MODIFIER61 from Resolution Performance Products), cresyl glycidyl ether (for example, HELOXY MODIFIER 62 from Resolution Performance Products), p-tert-butylphenyl glycidyl ether (for example, Heloxy Modifier 65 from Resolution Performance Products), polyfunctional glycidyl ethers such as diglycidyl ether of 1,4-butanediol (for example, HELOXY MODIFIER 67 from Resolution Performance Products), diglycidyl ether of neopentyl glycol (for example, HELOXY MODIFIER 68 from Resolution Performance Products), diglycidyl ether of cyclohexanedimethanol (for example, HELOXY MODIFIER 107 from Resolution Performance Products), trimethylol ethane triglycidyl ether (for example, HELOXY MODIFIER 44 from Resolution Performance Products), trimethylol propane triglycidyl ether (for example, HELOXY MODIFIER 48 from Resolution Performance Products), polyglycidyl ether of an aliphatic polyol (for example, HELOXY MODIFIER 84 from Resolution Performance Products), polyglycol diepoxide (for example, HELOXY MODIFIER 32 from Resolution Performance Products), bisphenol F epoxides (for example, those available under the trade designations EPON 1138 from Resolution Performance Products or GY-281 from Ciba-Geigy Corp.), and 9,9-bis[4-(2,3-epoxypropoxy)-phenyl]fluorenone (for example, those available under the trade designation EPON 1079 from Resolution Performance Products).

Other useful epoxy resins comprise copolymers of acrylic acid esters of glycidol (such as glycidylacrylate and glycidylmethacrylate) with one or more copolymerizable vinyl compounds. Examples of such copolymers are 1:1 styrene-glycidylmethacrylate, 1:1 methylmethacrylate-glycidylacrylate, and a 62.5:24:13.5 methylmethacrylate-ethyl acrylate-glycidylmethacrylate. Other useful epoxy resins are well known and contain such epoxides as epichlorohydrins, alkylene oxides (for example, propylene oxide), styrene oxide, alkenyl oxides (for example, butadiene oxide), and glycidyl esters (for example, ethyl glycidate).

Useful epoxy-functional polymers include epoxy-functional silicones such as those described in U.S. Pat. No. 4,279,717, which are commercially available from the General Electric Company. These are polydimethylsiloxanes in which 1-20 mole % of the silicon atoms have been substituted with epoxyalkyl groups (preferably, epoxy cyclohexylethyl, as described in U.S. Pat. No. 5,753,346.

Blends of various epoxy-containing materials can also be utilized. Such blends can comprise two or more weight average molecular weight distributions of epoxy-containing compounds (such as low molecular weight (below 200), intermediate molecular weight (about 200 to 10,000), and higher molecular weight (above about 10,000)). Alternatively or additionally, the epoxy resin can contain a blend of epoxy-containing materials having different chemical natures (such as aliphatic and aromatic) or functionalities (such as polar and non-polar). Other cationically-reactive polymers (such as vinyl ethers and the like) can additionally be incorporated, if desired.

Preferred epoxies include aromatic glycidyl epoxies (such as the EPON resins available from Resolution Performance Products) and cycloaliphatic epoxies (such as ERL 4221 and ERL 4299 available from Union Carbide).

Suitable cationally-reactive species also include vinyl ether monomers, oligomers, and reactive polymers (for example, methyl vinyl ether, ethyl vinyl ether, tert-butyl vinyl ether, isobutyl vinyl ether, triethyleneglycol divinyl ether (for example, those available under the trade designation RAPI-CURE DVE-3 from International Specialty Products, Wayne, N.J.), trimethylolpropane trivinyl ether (for example, those available under the trade designation TMPTVE from BASF Corp., Mount Olive, N.J.), and those available under the trade designation VECTOMER divinyl ether resins from Allied Signal (for example, VECTOMER 2010, VECTOMER 2020, VECTOMER 4010, and VECTOMER 4020 and their equivalents available from other manufacturers)), and mixtures thereof. Blends (in any proportion) of one or more vinyl ether resins and/or one or more epoxy resins can also be utilized. Polyhydroxy-functional materials (such as those described, for example, in U.S. Pat. No. 5,856,373 (Kaisaki et al.)) can also be utilized in combination with epoxy- and/or vinyl ether-functional materials.

Non-curable species include, for example, reactive polymers whose solubility can be increased upon acid- or radical-induced reaction. Such reactive polymers include, for example, aqueous insoluble polymers bearing ester groups that can be converted by photogenerated acid to aqueous soluble acid groups (for example, poly(4-tert-butoxycarbonyloxystyrene). Non-curable species also include the chemically-amplified photoresists described by R. D. Allen, G. M. Wallraff, W. D. Hinsberg, and L. L. Simpson in “High Performance Acrylic Polymers for Chemically Amplified Photoresist Applications,” J. Vac. Sci. Technol. B, 9, 3357 (1991). The chemically-amplified photoresist concept is now widely used for microchip manufacturing, especially with sub-0.5 micron (or even sub-0.2 micron) features. In such photoresist systems, catalytic species (typically hydrogen ions) can be generated by irradiation, which induces a cascade of chemical reactions. This cascade occurs when hydrogen ions initiate reactions that generate more hydrogen ions or other acidic species, thereby amplifying reaction rate. Examples of typical acid-catalyzed chemically-amplified photoresist systems include deprotection (for example, t-butoxycarbonyloxystyrene resists as described in U.S. Pat. No. 4,491,628, tetrahydropyran (THP) methacrylate-based materials, THP-phenolic materials such as those described in U.S. Pat. No. 3,779,778, t-butyl methacrylate-based materials such as those described by R. D Allen et al. in Proc. SPIE 2438, 474 (1995), and the like); depolymerization (for example, polyphthalaldehyde-based materials); and rearrangement (for example, materials based on the pinacol rearrangements).

Multiphoton Photoinitiator System

(1) Multiphoton Photosensitizers

Multiphoton photosensitizers suitable for use in the multiphoton curable composition are capable of simultaneously absorbing at least two photons when exposed to radiation from an appropriate light source in the exposure system. Preferred multiphoton photosensitizers have a two-photon absorption cross-section greater than that of fluorescein (that is, greater than that of 3′, 6′-dihydroxyspiro[isobenzofuran-1(3H), 9′-[9H]xanthen]3-one). Generally, the two photon absorption cross-section can be greater than about 50×10⁻⁵⁰ cm⁴ sec/photon, as measured by the method described by C. Xu and W. W. Webb in J. Opt. Soc. Am. B, 13, 481 (1996) and WO 98/21521.

This method involves the comparison (under identical excitation intensity and photosensitizer concentration conditions) of the two-photon fluorescence intensity of the photosensitizer with that of a reference compound. The reference compound can be selected to match as closely as possible the spectral range covered by the photosensitizer absorption and fluorescence. In one possible experimental set-up, an excitation beam can be split into two arms, with 50% of the excitation intensity going to the photosensitizer and 50% to the reference compound. The relative fluorescence intensity of the photosensitizer with respect to the reference compound can then be measured using two photomultiplier tubes or other calibrated detector. Finally, the fluorescence quantum efficiency of both compounds can be measured under one-photon excitation.

Methods of determining fluorescence and phosphorescence quantum yields are well-known in the art. Typically, the area under the fluorescence (or phosphorescence) spectrum of a compound of interest is compared with the area under the fluorescence (or phosphorescence) spectrum of a standard luminescent compound having a known fluorescence (or phosphorescence) quantum yield, and appropriate corrections are made (which take into account, for example, the optical density of the composition at the excitation wavelength, the geometry of the fluorescence detection apparatus, the differences in the emission wavelengths, and the response of the detector to different wavelengths). Standard methods are described, for example, by I. B. Berlman in Handbook of Fluorescence Spectra of Aromatic Molecules, Second Edition, pages 24-27, Academic Press, New York (1971); by J. N. Demas and G. A. Crosby in J. Phys. Chem. 75, 991-1024 (1971); and by J. V. Morris, M. A. Mahoney, and J. R. Huber in J. Phys. Chem. 80 969-974 (1976).

Assuming that the emitting state is the same under one- and two-photon excitation (a common assumption), the two-photon absorption cross-section of the photosensitizer, (δₛₐₘ), is equal to δ_{ref} K (Iₛₐₘ/I_{ref})(Φₛₐₘ/Φ_{ref}), wherein δ_{ref} is the two-photon absorption cross-section of the reference compound, Iₛₐₘ is the fluorescence intensity of the photosensitizer, I_{ref} is the fluorescence intensity of the reference compound, Φₛₐₘ is the fluorescence quantum efficiency of the photosensitizer, Φ_{ref} is the fluorescence quantum efficiency of the reference compound, and K is a correction factor to account for slight differences in the optical path and response of the two detectors. K can be determined by measuring the response with the same photosensitizer in both the sample and reference arms. To ensure a valid measurement, the clear quadratic dependence of the two-photon fluorescence intensity on excitation power can be confirmed, and relatively low concentrations of both the photosensitizer and the reference compound can be utilized (to avoid fluorescence reabsorption and photosensitizer aggregration effects).

When the photosensitizer is not fluorescent, the yield of electronic excited states can to be measured and compared with a known standard. In addition to the above-described method of determining fluorescence yield, various methods of measuring excited state yield are known (including, for example, transient absorbance, phosphorescence yield, photoproduct formation or disappearance of photosensitizer (from photoreaction), and the like).

Preferably, the two-photon absorption cross-section of the photosensitizer is greater than about 1.5 times that of fluorescein (or, alternatively, greater than about 75×10⁻⁵⁰ cm⁴ sec/photon, as measured by the above method); more preferably, greater than about twice that of fluorescein (or, alternatively, greater than about 100×10⁻⁵⁰ cm⁴ sec/photon); most preferably, greater than about three times that of fluorescein (or, alternatively, greater than about 150×10⁻⁵⁰ cm⁴ sec/photon); and optimally, greater than about four times that of fluorescein (or, alternatively, greater than about 200×10⁻⁵⁰ cm⁴ sec/photon).

Preferably, the photosensitizer is soluble in the reactive species (if the reactive species is liquid) or is compatible with the reactive species and with any binders (as described below) that are included in the multiphoton curable composition. Most preferably, the photosensitizer is also capable of sensitizing 2-methyl-4,6-bis(trichloromethyl)-s-triazine under continuous irradiation in a wavelength range that overlaps the single photon absorption spectrum of the photosensitizer (single photon absorption conditions), using the test procedure described in U.S. Pat. No. 3,729,313. Using currently available materials, that test can be carried out as follows:

A standard test solution can be prepared having the following composition: 5.0 parts of a 5% (weight by volume) solution in methanol of 45,000-55,000 molecular weight, 9.0-13.0% hydroxyl content polyvinyl butyral (for example, those available under the trade designation BUTVAR B76 from Monsanto); 0.3 parts trimethylolpropane trimethacrylate; and 0.03 parts 2-methyl-4,6-bis(trichloromethyl)-s-triazine (see Bull. Chem. Soc. Japan, 42, 2924-2930 (1969)). To this solution can be added 0.01 parts of the compound to be tested as a photosensitizer. The resulting solution can then be knife-coated onto a 0.05 mm clear polyester film using a knife orifice of 0.05 mm, and the coating can be air dried for about 30 minutes. A 0.05 mm clear polyester cover film can be carefully placed over the dried but soft and tacky coating with minimum entrapment of air. The resulting sandwich construction can then be exposed for three minutes to 161,000 Lux of incident light from a tungsten light source providing light in both the visible and ultraviolet range (such as that produced from a FCH 650 W quartz-iodine lamp, available from General Electric). Exposure can be made through a stencil to provide exposed and unexposed areas in the construction. After exposure the cover film can be removed, and the coating can be treated with a finely divided colored powder, such as a color toner powder of the type conventionally used in xerography. If the tested compound is a photosensitizer, the trimethylolpropane trimethacrylate monomer will be polymerized in the light-exposed areas by the light-generated free radicals from the 2-methyl-4,6-bis(trichloromethyl)-s-triazine. Since the polymerized areas will be essentially tack-free, the colored powder will selectively adhere essentially only to the tacky, unexposed areas of the coating, providing a visual image corresponding to that in the stencil.

Preferably, a photosensitizer can also be selected based in part upon shelf stability considerations. Accordingly, selection of a particular photosensitizer can depend to some extent upon the particular reactive species utilized (as well as upon the choices of electron donor compound and/or electron acceptor).

Particularly preferred multiphoton photosensitizers include those exhibiting large multiphoton absorption cross-sections, such as Rhodamine B (that is, N-[9-(2-carboxyphenyl)-6-(diethylamino)-3H-xanthen-3-ylidene]-N-ethylethanaminium chloride and the hexafluoroantimonate salt of Rhodamine B) and the four classes of photosensitizers described, for example, by Marder and Perry et al. WO 98/21521 and WO 99/53242. The four classes can be described as follows: (a) molecules in which two donors are connected to a conjugated π-electron bridge; (b) molecules in which two donors are connected to a conjugated π-electron bridge which is substituted with one or more electron accepting groups; (c) molecules in which two acceptors are connected to a conjugated π-electron bridge; and (d) molecules in which two acceptors are connected to a conjugated π-electron bridge which is substituted with one or more electron donating groups (where “bridge” means a molecular fragment that connects two or more chemical groups, “donor” means an atom or group of atoms with a low ionization potential that can be bonded to a conjugated π-electron bridge, and “acceptor” means an atom or group of atoms with a high electron affinity that can be bonded to a conjugated π-electron bridge).

Representative examples of such photosensitizers include the following:

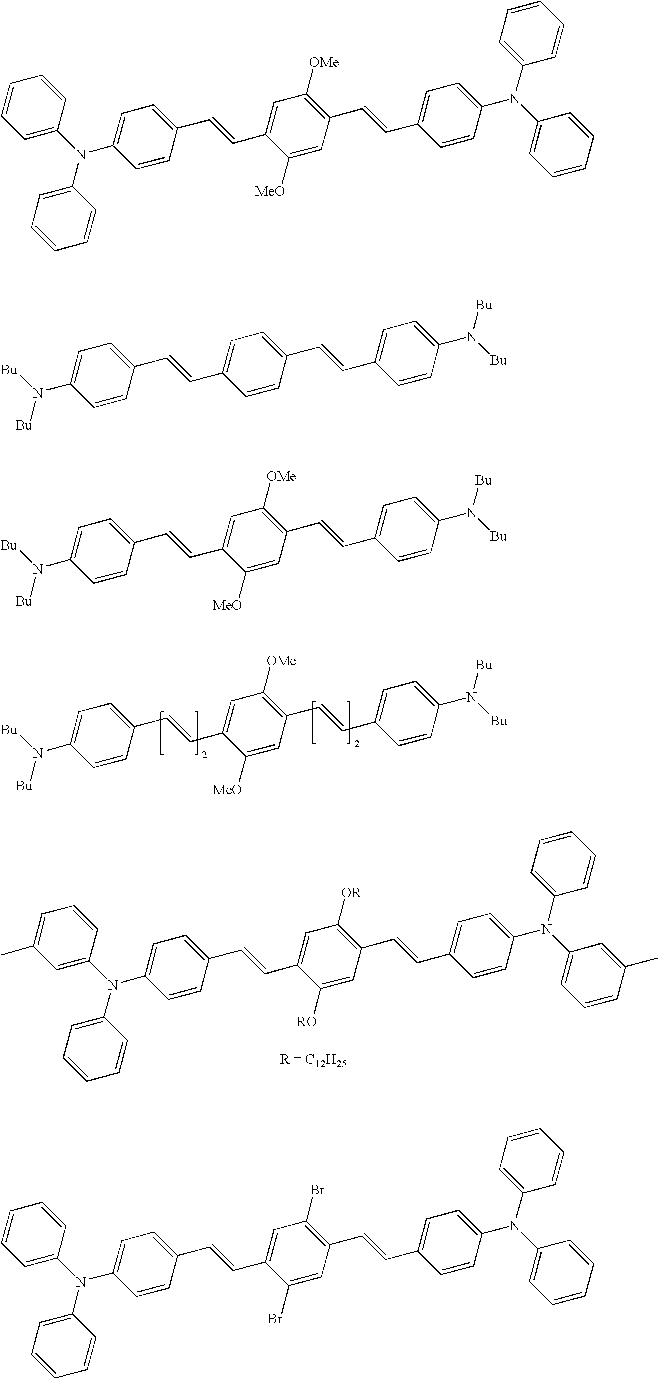

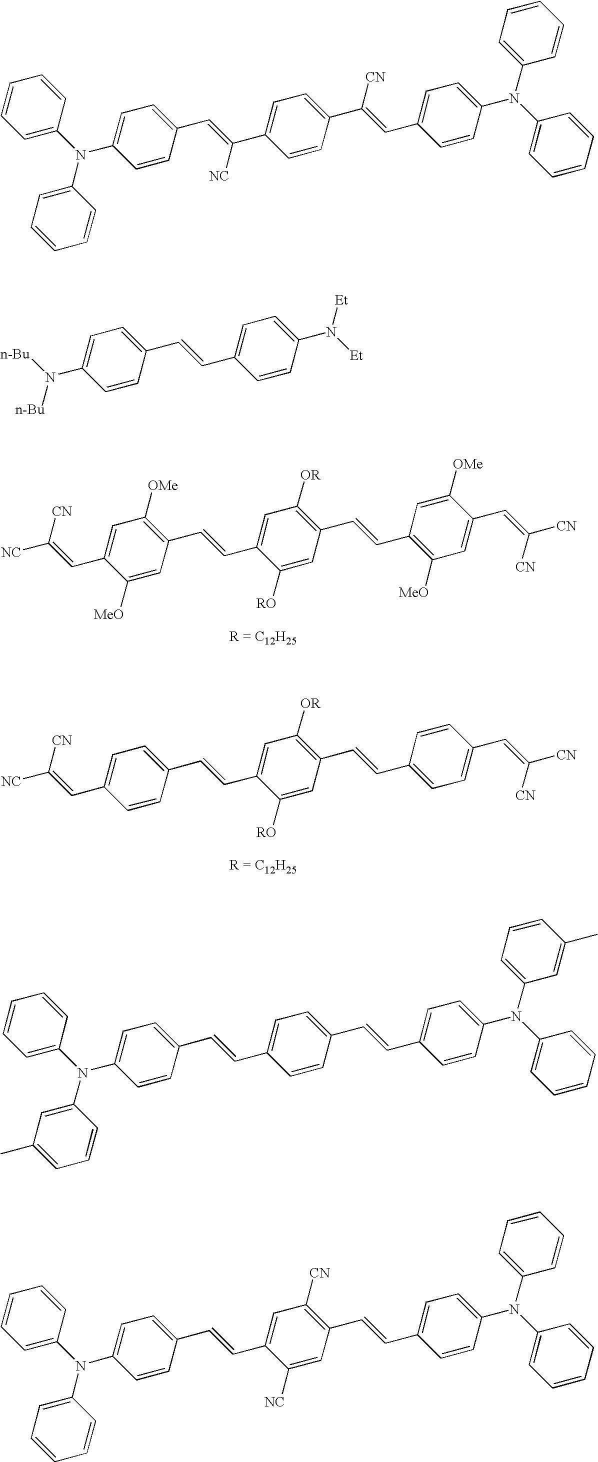

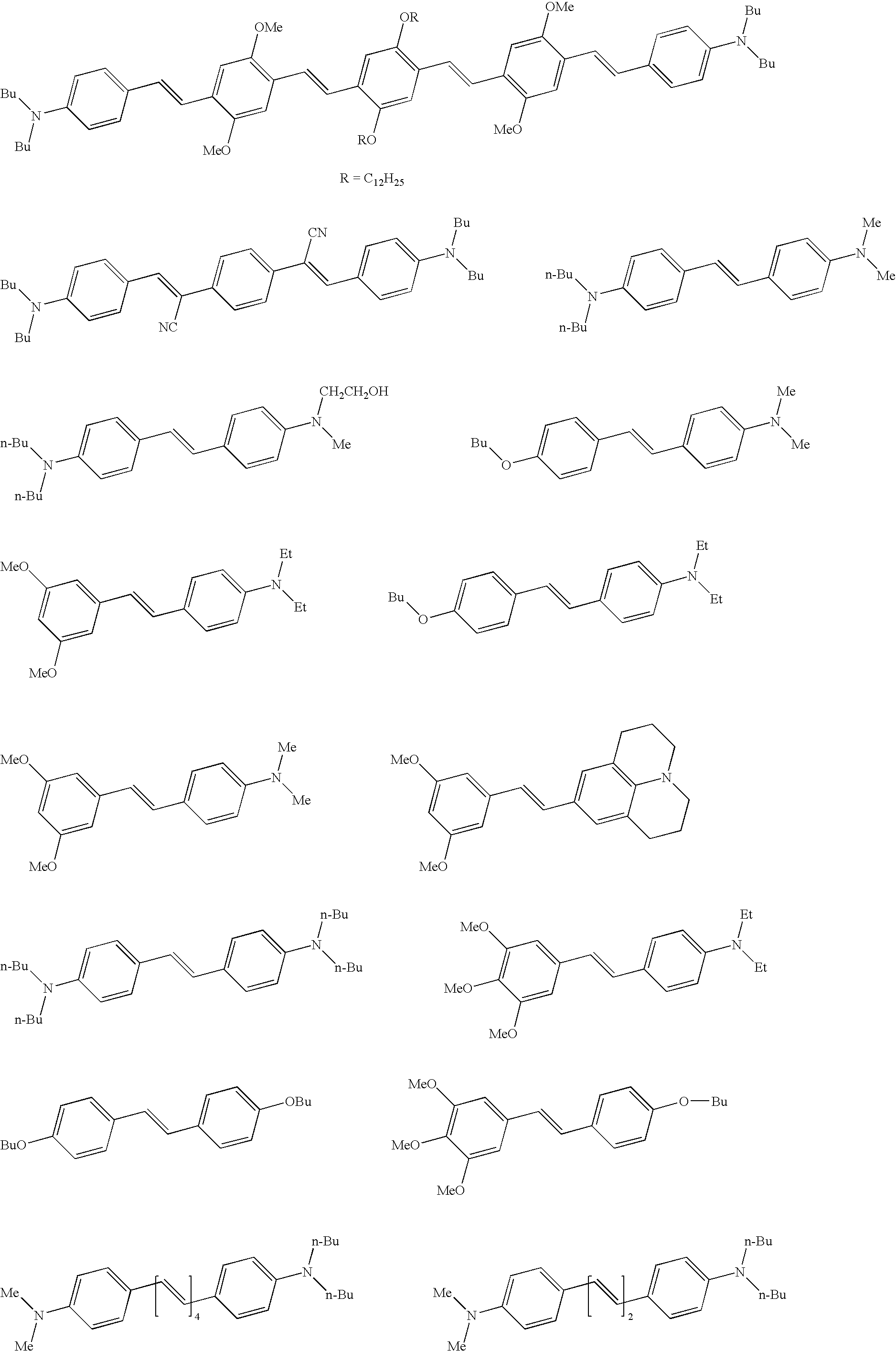

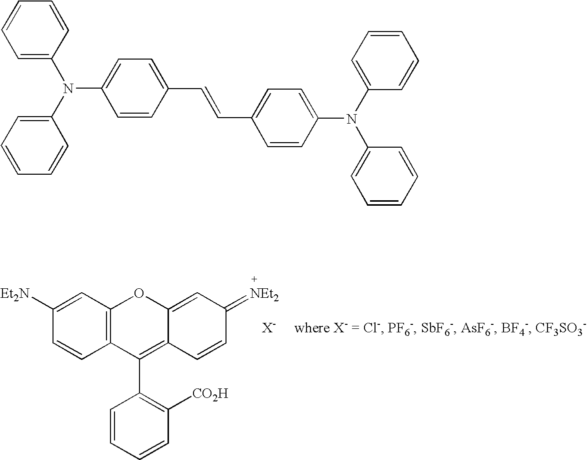

The four classes of photosensitizers described above can be prepared by reacting aldehydes with ylides under standard Wittig conditions or by using the McMurray reaction, as detailed in WO 98/21521.

Other suitable compounds are described in U.S. Pat. Nos. 6,100,405, 5,859,251, and 5,770,737 as having large multiphoton absorption cross-sections, although these cross-sections were determined by a method other than that described above. Representative examples of such compounds include the following:

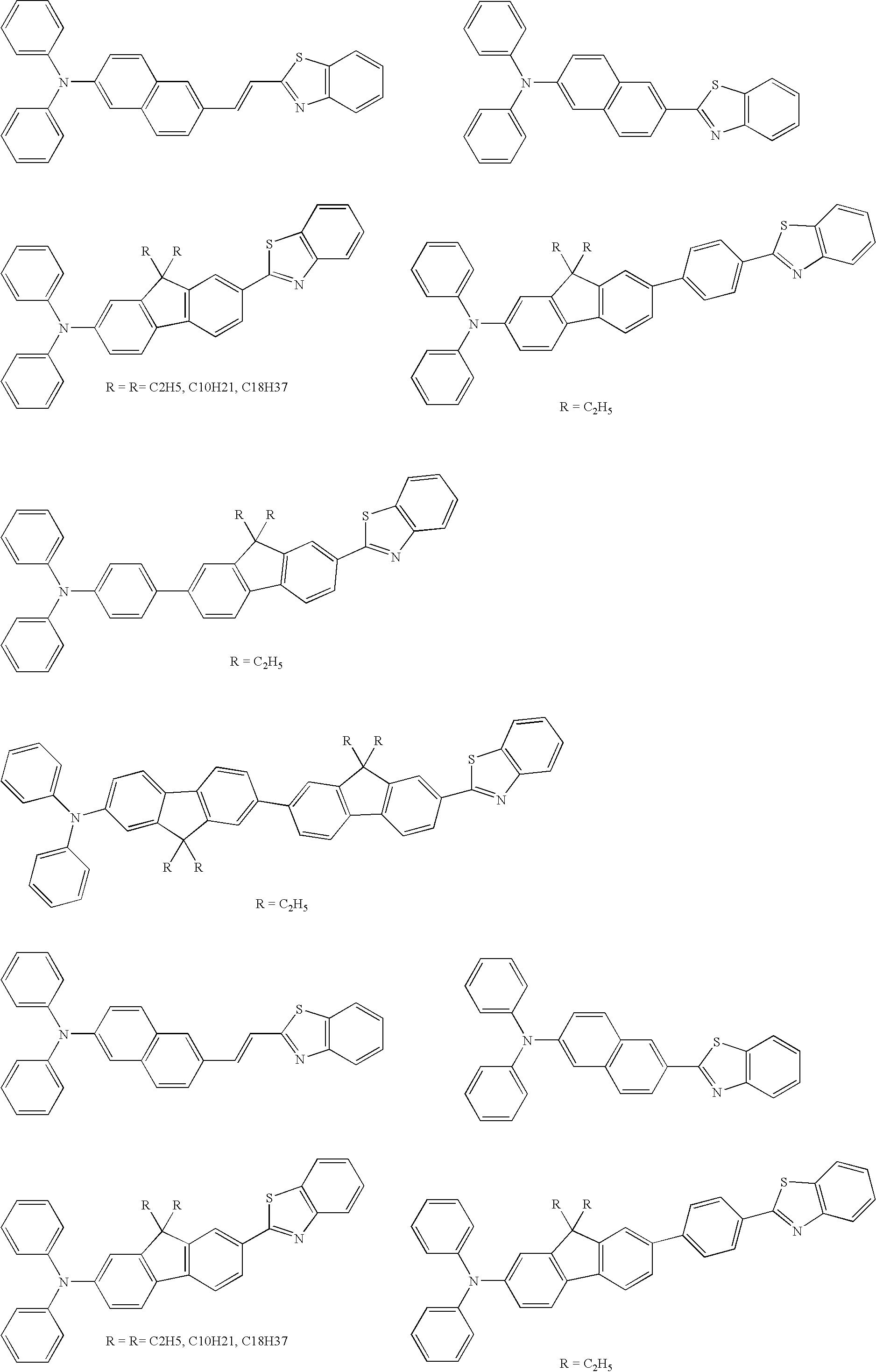

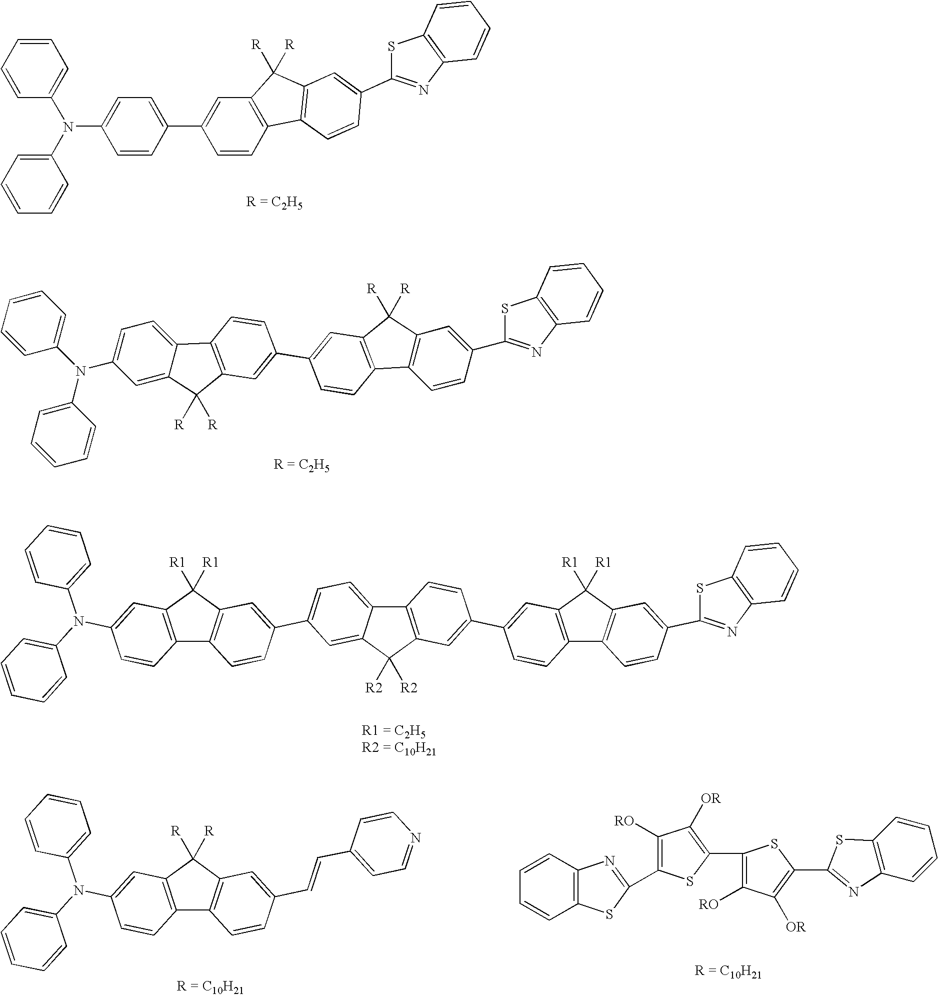

(2) Electron Acceptor

Suitable electron acceptors for the multiphoton curable compositions are capable of being photosensitized by accepting an electron from an electronic excited state of the multiphoton photosensitizer, resulting in the formation of at least one free radical and/or acid. Such electron acceptors include iodonium salts (for example, diaryliodonium salts), chloromethylated triazines (for example, 2-methyl-4,6-bis(trichloromethyl)-s-triazine, 2,4,6-tris(trichloromethyl)-s-triazine, and 2-aryl-4,6-bis(trichloromethyl)-s-triazine), diazonium salts (for example, phenyldiazonium salts optionally substituted with groups such as alkyl, alkoxy, halo, or nitro), sulfonium salts (for example, triarylsulfonium salts optionally substituted with alkyl or alkoxy groups, and optionally having 2,2′ oxy groups bridging adjacent aryl moieties), azinium salts (for example, an N-alkoxypyridinium salt), and triarylimidazolyl dimers (preferably, 2,4,5-triphenylimidazolyl dimers such as 2,2′,4,4′,5,5′-tetraphenyl-1,1′-biimidazole, optionally substituted with groups such as alkyl, alkoxy, or halo), and the like, and mixtures thereof.

The electron acceptor is preferably soluble in the reactive species and is preferably shelf-stable (that is, does not spontaneously promote reaction of the reactive species when dissolved therein in the presence of the photosensitizer and an electron donor compound). Accordingly, selection of a particular electron acceptor can depend to some extent upon the particular reactive species, photosensitizer, and electron donor compound chosen, as described above.

Suitable iodonium salts include those described in U.S. Pat. Nos. 5,545,676, 3,729,313, 3,741,769, 3,808,006, 4,250,053 and 4,394,403. The iodonium salt can be a simple salt (for example, containing an anion such as Cl—, Br—, I— or C₄H₅SO₃—) or a metal complex salt (for example, containing SbF₆—, PF₆—, BF₄—, tetrakis(perfluorophenyl)borate, SbF₅ OH— or AsF₆—). Mixtures of iodonium salts can be used if desired.

Examples of useful aromatic iodonium complex salt electron acceptors include diphenyliodonium tetrafluoroborate; di(4-methylphenyl)iodonium tetrafluoroborate; phenyl-4-methylphenyliodonium tetrafluoroborate; di(4-heptylphenyl)iodonium tetrafluoroborate; di(3-nitrophenyl)iodonium hexafluorophosphate; di(4-chlorophenyl)iodonium hexafluorophosphate; di(naphthyl)iodonium tetrafluoroborate; di(4-trifluoromethylphenyl)iodonium tetrafluoroborate; diphenyliodonium hexafluorophosphate; di(4-methylphenyl)iodonium hexafluorophosphate; diphenyliodonium hexafluoroarsenate; di(4-phenoxyphenyl)iodonium tetrafluoroborate; phenyl-2-thienyliodonium hexafluorophosphate; 3,5-dimethylpyrazolyl-4-phenyliodonium hexafluorophosphate; diphenyliodonium hexafluoroantimonate; 2,2′-diphenyliodonium tetrafluoroborate; di(2,4-dichlorophenyl)iodonium hexafluorophosphate; di(4-bromophenyl)iodonium hexafluorophosphate; di(4-methoxyphenyl)iodonium hexafluorophosphate; di(3-carboxyphenyl)iodonium hexafluorophosphate; di(3-methoxycarbonylphenyl)iodonium hexafluorophosphate; di(3-methoxysulfonylphenyl)iodonium hexafluorophosphate; di(4-acetainidophenyl)iodonium hexafluorophosphate; di(2-benzothienyl)iodonium hexafluorophosphate; and diphenyliodonium hexafluoroantimonate; and the like; and mixtures thereof. Aromatic iodonium complex salts can be prepared by metathesis of corresponding aromatic iodonium simple salts (such as, for example, diphenyliodonium bisulfate) in accordance with the teachings of Beringer et al., J. Am. Chem. Soc. 81, 342 (1959).

Preferred iodonium salts include diphenyliodonium salts (such as diphenyliodonium chloride, diphenyliodonium hexafluorophosphate, and diphenyliodonium tetrafluoroborate), diaryliodonium hexafluoroantimonate (for example, those available under the trade designation SARCAT SR 1012 from Sartomer Company), and mixtures thereof.

Suitable anions, X—, for the sulfonium salts (and for any of the other types of electron acceptors) include a variety of anion types such as, for example, imide, methide, boron-centered, phosphorous-centered, antimony-centered, arsenic-centered, and aluminum-centered anions.

Illustrative, but not limiting, examples of suitable imide and methide anions include (C₂F₅SO₂)₂N⁻, (C₄F₉SO₂)₂N⁻, (C₈F₁₇SO₂)₃C⁻, (CF₃SO₂)₃C⁻, (CF₃SO₂)₂N⁻, (C₄F₉SO₂)₃C⁻, (CF₃SO₂)₂(C₄F₉SO₂)C⁻, (CF₃SO₂)(C₄F₉SO₂)N⁻, ((CF₃)₂NC₂F₄SO₂)₂N⁻, (CF₃)₂NC₂F₄SO₂C⁻(SO₂ CF₃)₂, (3,5-bis(CF₃)C₆H₃)SO₂N⁻SO₂CF₃, C₆H₅SO₂C⁻(SO₂CF₃)₂, C₆H₅SO₂N⁻SO₂CF₃, and the like. Preferred anions of this type include those represented by the formula (R_{f}SO₂)₃C⁻, wherein R_{f} is a perfluoroalkyl radical having from 1 to about 4 carbon atoms.

Illustrative, but not limiting, examples of suitable boron-centered anions include F₄B⁻, (3,5-bis(CF₃)C₆H₃)₄B⁻, (C₆F₅)₄B⁻, (p-CF₃C₆H₄)₄B⁻, (m-CF₃C₆H₄)₄B⁻, (p-FC₆H₄)₄B⁻, (C₆F₅)₃(CH₃)B⁻, (C₆F₅)₃(n-C₄H₉)B⁻, (p-CH₃C₆H₄)₃(C₆F₅)B⁻, (C₆F₅)₃FB⁻, (C₆H₅)₃(C₆F₅)B⁻, (CH₃)₂(p-CF₃C₆H₄)₂B⁻, (C₆F₅)₃(n-C₁₈H₃₇O)B⁻, and the like. Preferred boron-centered anions generally contain 3 or more halogen-substituted aromatic hydrocarbon radicals attached to boron, with fluorine being the most preferred halogen. Illustrative, but not limiting, examples of the preferred anions include (3,5-bis(CF₃)C₆H₃)₄B⁻, (C₆F₅)₄B⁻, (C₆F₅)₃(n-C₄H₉)B⁻, (C₆F₅)₃FB⁻, and (C₆F₅)₃(CH₃)B⁻.

Suitable anions containing other metal or metalloid centers include, for example, (3,5-bis(CF₃)C₆H₃)₄Al⁻, (C₆F₅)₄Al⁻, (C₆F₅)₂F₄P⁻, (C₆F₅)F₅P⁻, F₆P⁻, (C₆F₅)F₅Sb⁻, F₆Sb⁻, (HO)F₅Sb⁻, and F₆As⁻. Preferably, the anion, X—, is selected from tetrafluoroborate, hexafluorophosphate, hexafluoroarsenate, hexafluoroantimonate, and hydroxypentafluoroantimonate (for example, for use with cationically-reactive species such as epoxy resins).

Examples of suitable sulfonium salt electron acceptors include:

triphenylsulfonium tetrafluoroborate

methyldiphenylsulfonium tetrafluoroborate

dimethylphenylsulfonium hexafluorophosphate

triphenylsulfonium hexafluorophosphate

triphenylsulfonium hexafluoroantimonate

diphenylnaphthylsulfonium hexafluoroarsenate

tritolysulfonium hexafluorophosphate

anisyldiphenylsulfonium hexafluoroantimonate

4-butoxyphenyldiphenylsulfonium tetrafluoroborate

4-chlorophenyldiphenylsulfonium hexafluorophosphate

tri(4-phenoxyphenyl)sulfonium hexafluorophosphate

di(4-ethoxyphenyl)methylsulfonium hexafluoroarsenate

4-acetonylphenyldiphenylsulfonium tetrafluoroborate

4-thiomethoxyphenyldiphenylsulfonium hexafluorophosphate

di(methoxysulfonylphenyl)methylsulfonium hexafluoroantimonate

di(nitrophenyl)phenylsulfonium hexafluoroantimonate

di(carbomethoxyphenyl)methylsulfonium hexafluorophosphate

4-acetamidophenyldiphenylsulfonium tetrafluoroborate

dimethylnaphthylsulfonium hexafluorophosphate

trifluoromethyldiphenylsulfonium tetrafluoroborate

p-(phenylthiophenyl)diphenylsulfonium hexafluoroantimonate

10-methylphenoxathiinium hexafluorophosphate

5-methylthianthrenium hexafluorophosphate

10-phenyl-9,9-dimethylthioxanthenium hexafluorophosphate

10-phenyl-9-oxothioxanthenium tetrafluoroborate

5-methyl-10-oxothianthrenium tetrafluoroborate

5-methyl-10,10-dioxothianthrenium hexafluorophosphate

Preferred sulfonium salts include triaryl-substituted salts such as triarylsulfonium hexafluoroantimonate (for example, those available under the trade designation SARCAT SR1010 from Sartomer Company), triarylsulfonium hexafluorophosphate (for example, those available under the trade designation SARCAT SR 1011 from Sartomer Company), and triarylsulfonium hexafluorophosphate (for example, those available under the trade designation SARCAT KI85 from Sartomer Company).

Useful azinium salts include those described in U.S. Pat. No. 4,859,572 which include an azinium moiety, such as a pyridinium, diazinium, or triazinium moiety. The azinium moiety can include one or more aromatic rings, typically carbocyclic aromatic rings (for example, quinolinium, isoquinolinium, benzodiazinium, and naphthodiazonium moieties), fused with an azinium ring. A quaternizing substituent of a nitrogen atom in the azinium ring can be released as a free radical upon electron transfer from the electronic excited state of the photosensitizer to the azinium electron acceptor. In one preferred form, the quaternizing substituent is an oxy substituent. The oxy substituent, —O—T, which quaternizes a ring nitrogen atom of the azinium moiety can be selected from among a variety of synthetically convenient oxy substituents. The moiety T can, for example, be an alkyl radical, such as methyl, ethyl, butyl, and so forth. The alkyl radical can be substituted. For example, aralkyl (for example, benzyl and phenethyl) and sulfoalkyl (for example, sulfomethyl) radicals can be useful. In another form, T can be an acyl radical, such as an —OC(O)—T¹ radical, where T¹ can be any of the various allyl and aralkyl radicals described above. In addition, T¹ can be an aryl radical, such as phenyl or naphthyl. The aryl radical can in turn be substituted. For example, T¹ can be a tolyl or xylyl radical. T typically contains from 1 to about 18 carbon atoms, with alkyl moieties in each instance above preferably being lower alkyl moieties and aryl moieties in each instance preferably containing about 6 to about 10 carbon atoms. Highest activity levels have been realized when the oxy substituent, —O—T, contains 1 or 2 carbon atoms. The azinium nuclei need include no substituent other than the quaternizing substituent. However, the presence of other substituents is not detrimental to the activity of these electron acceptors.

Useful triarylimidazolyl dimers include those described in U.S. Pat. No. 4,963,471. These dimers include, for example, 2-(o-chlorophenyl)-4,5-bis(m-methoxyphenyl)-1,1′-biimidazole; 2,2′-bis(o-chlorophenyl)-4,4′,5,5′-tetraphenyl-1,1′-biimidazole; and 2,5-bis(o-chlorophenyl)-4-[3,4-dimethoxyphenyl]-1,1′-biimidazole.

Preferred electron acceptors include photoacid generators, such as iodonium salts (more preferably, aryliodonium salts), chloromethylated triazines, sulfonium salts, and diazonium salts. More preferred are aryliodonium salts and chloromethylated triazines.

(3) Electron Donor Compounds

Electron donor compounds useful in the multiphoton photosensitizer system of the multiphoton curable composition are compounds (other than the photosensitizer itself) that are capable of donating an electron to an electronic excited state of the photosensitizer. The electron donor compounds preferably have an oxidation potential that is greater than zero and less than or equal to that of p-dimethoxybenzene. Preferably, the oxidation potential is between about 0.3 and 1 V vs. a standard saturated calomel electrode (“S.C.E.”).

The electron donor compound is also preferably soluble in the reactive species and is selected based in part upon shelf stability considerations (as described above). Suitable donors are generally capable of increasing the speed of cure or the image density of a photoreactive composition upon exposure to light of the desired wavelength.

When working with cationically-reactive species, those skilled in the art will recognize that the electron donor compound, if of significant basicity, can adversely affect the cationic reaction. (See, for example, the discussion in U.S. Pat. No. 6,025,406.)

In general, electron donor compounds suitable for use with particular photosensitizers and electron acceptors can be selected by comparing the oxidation and reduction potentials of the three components (as described, for example, in U.S. Pat. No. 4,859,572). Such potentials can be measured experimentally (for example, by the methods described by R. J. Cox, Photographic Sensitivity, Chapter 15, Academic Press (1973)) or can be obtained from references such as N. L. Weinburg, Ed., Technique of Electroorganic Synthesis Part II Techniques of Chemistry, Vol. V (1975), and C. K. Mann and K. K. Barnes, Electrochemical Reactions in Nonaqueous Systems (1970). The potentials reflect relative energy relationships and can be used in the manner described below to guide electron donor compound selection.

When the photosensitizer is in an electronic excited state, an electron in the highest occupied molecular orbital (HOMO) of the photosensitizer has been lifted to a higher energy level (namely, the lowest unoccupied molecular orbital (LUMO) of the photosensitizer), and a vacancy is left behind in the molecular orbital it initially occupied. The electron acceptor can accept the electron from the higher energy orbital, and the electron donor compound can donate an electron to fill the vacancy in the originally occupied orbital, provided that certain relative energy relationships are satisfied.

If the reduction potential of the electron acceptor is less negative (or more positive) than that of the photosensitizer, an electron in the higher energy orbital of the photosensitizer is readily transferred from the photosensitizer to the lowest unoccupied molecular orbital (LUMO) of the electron acceptor, since this represents an exothermic process. Even if the process is instead slightly endothermic (that is, even if the reduction potential of the photosensitizer is up to 0.1 volt more negative than that of the electron acceptor) ambient thermal activation can readily overcome such a small barrier.

In an analogous manner, if the oxidation potential of the electron donor compound is less positive (or more negative) than that of the photosensitizer, an electron moving from the HOMO of the electron donor compound to the orbital vacancy in the photosensitizer is moving from a higher to a lower potential, which again represents an exothermic process. Even if the process is slightly endothermic (that is, even if the oxidation potential of the photosensitizer is up to 0.1 V more positive than that of the electron donor compound), ambient thermal activation can readily overcome such a small barrier.

Slightly endothermic reactions in which the reduction potential of the photosensitizer is up to 0.1 V more negative than that of the electron acceptor, or the oxidation potential of the photosensitizer is up to 0.1 V more positive than that of the electron donor compound, occur in every instance, regardless of whether the electron acceptor or the electron donor compound first reacts with the photosensitizer in its excited state. When the electron acceptor or the electron donor compound is reacting with the photosensitizer in its excited state, it is preferred that the reaction be exothermic or only slightly endothermic. When the electron acceptor or the electron donor compound is reacting with the photosensitizer ion radical, exothermic reactions are still preferred, but still more endothermic reactions can be expected in many instances to occur. Thus, the reduction potential of the photosensitizer can be up to 0.2 V (or more) more negative than that of a second-to-react electron acceptor, or the oxidation potential of the photosensitizer can be up to 0.2 V (or more) more positive than that of a second-to-react electron donor compound.

Suitable electron donor compounds include, for example, those described by D. F. Eaton in Advances in Photochemistry, edited by B. Voman et al., Volume 13, pp. 427-488, John Wiley and Sons, New York (1986); U.S. Pat. Nos. 6,025,406, and 5,545,676. Such electron donor compounds include amines (including triethanolamine, hydrazine, 1,4-diazabicyclo[2.2.2]octane, triphenylamine (and its triphenylphosphine and triphenylarsine analogs), aminoaldehydes, and aminosilanes), amides (including phosphoramides), ethers (including thioethers), ureas (including thioureas), sulfinic acids and their salts, salts of ferrocyanide, ascorbic acid and its salts, dithiocarbamic acid and its salts, salts of xanthates, salts of ethylene diamine tetraacetic acid, salts of (alkyl)ₙ(aryl)ₘborates (n+m=4)(tetraalkylammonium salts preferred), various organometallic compounds such as SnR₄ compounds (where each R is independently chosen from among alkyl, arylalkyl (particularly, benzyl), aryl, and alkaryl groups) (for example, such compounds as n-C₃H₇Sn(CH₃)₃, (allyl)Sn(CH₃)₃, and (benzyl)Sn(n-C₃H₇)₃), ferrocene, and the like, and mixtures thereof. The electron donor compound can be unsubstituted or can be substituted with one or more non-interfering substituents. Particularly preferred electron donor compounds contain an electron donor atom (such as a nitrogen, oxygen, phosphorus, or sulfur atom) and an abstractable hydrogen atom bonded to a carbon or silicon atom alpha to the electron donor atom.

Preferred amine electron donor compounds include alkyl-, aryl-, alkaryl- and aralkyl-amines (for example, methylamine, ethylamine, propylamine, butylamine, triethanolamine, amylamine, hexylamine, 2,4-dimethylaniline, 2,3-dimethylaniline, o-, m- and p-toluidine, benzylamine, aminopyridine, N,N′-dimethylethylenediamine, N,N′-diethylethylenediamine, N,N′-dibenzylethylenediamine, N,N′-diethyl-1,3-propanediamine, N,N′-diethyl-2-butene-1,4-diamine, N,N′-dimethyl-1,6-hexanediamine, piperazine, 4,4′-trimethylenedipiperidine, 4,4′-ethylenedipiperidine, p-N,N-dimethyl-aminophenethanol and p-N-dimethylaminobenzonitrile); aminoaldehydes (for example, p-N,N-dimethylaminobenzaldehyde, p-N,N-dimethylaminobenzaldehyde, 9-julolidine carboxaldehyde, and 4-morpholinobenzaldehyde); and aminosilanes (for example, trimethylsilylmorpholine, trimethylsilylpiperidine, bis(dimethylamino)diphenylsilane, tris(dimethylamino)methylsilane, N,N-diethylaminotrimethylsilane, tris(dimethylamino)phenylsilane, tris(methylsilyl)amine, tris(dimethylsilyl)amine, bis(dimethylsilyl)amine, N,N-bis(dimethylsilyl)aniline, N-phenyl-N-dimethylsilylaniline, and N,N-dimethyl-N-dimethylsilylamine); and mixtures thereof Tertiary aromatic alkylamines, particularly those having at least one electron-withdrawing group on the aromatic ring, have been found to provide especially good shelf stability. Good shelf stability has also been obtained using amines that are solids at room temperature. Good photographic speed has been obtained using amines that contain one or more ulolidinyl moieties.

Preferred amide electron donor compounds include N,N-dimethylacetamide, N,N-diethylacetamide, N-methyl-N-phenylacetamide, hexamethylphosphoramide, hexaethylphosphoramide, hexapropylphosphoramide, trimorpholinophosphine oxide, tripiperidinophosphine oxide, and mixtures thereof.

Preferred alkylarylborate salts include

Ar₃B⁻(n-C₄H₉)N⁺(C₂H₅)₄

Ar₃B⁻(n-C₄H₉)N⁺(CH₃)₄

Ar₃B⁻(n-C₄H₉)N⁺(n-C₄H₉)₄

Ar₃B⁻(n-C₄H,)Li⁺

Ar₃B⁻(n-C₄H₉)N⁺(C₆H₁₃)₄

Ar₃B⁻—(C₄H₉)N⁺(CH₃)₃(CH₂)₂CO₂(CH₂)₂CH₃

Ar₃B⁻—(C₄H₉)N⁺(CH₃)₃(CH₂)₂OCO(CH₂)₂CH₃

Ar₃B⁻—(sec-C₄H₉)N⁺(CH₃)₃(CH₂)₂CO₂(CH₂) ₂CH₃

Ar₃B⁻—(sec-C₄H₉)N⁺(C₆H₁₃)₄

Ar₃B⁻—(C₄H₉)N⁺(C₈H₁₇)₄

Ar₃B⁻—(C₄H₉)N⁺(CH₃)₄

(p-CH₃O—C₆H₄)₃B⁻(n-C₄H₉)N⁺(n-C₄H₉)₄

Ar₃B⁻—(C₄H₉)N⁺(CH₃)₃(CH₂)₂OH

ArB⁻(n-C₄H₉)₃N⁺(CH₃)₄

ArB⁻(C₂H₅)₃N⁺(CH₃)₄

Ar₂B⁻(n-C₄H₉)₂N⁺(CH₃)₄

Ar₃B⁻(C₄H₉)N⁺(C₄H₉)₄

Ar₄B⁻N⁺(C₄H₉)₄

ArB⁻(CH₃)₃N⁺(CH₃)₄

(n-C₄H₉)₄B⁻N⁺(CH₃)₄

Ar₃B⁻(C₄H₉)P⁺(C₄H₉)₄

where Ar is phenyl, naphthyl, substituted (preferably, fluoro-substituted) phenyl, substituted naphthyl, and like groups having greater numbers of fused aromatic rings, as well as tetramethylammonium n-butyltriphenylborate and tetrabutylammonium n-hexyl-tris(3-fluorophenyl)borate (available under the trade designations CGI 437 and CGI 7460 from Ciba Specialty Chemicals Corporation), and mixtures thereof.

Suitable ether electron donor compounds include 4,4′-dimethoxybiphenyl, 1,2,4-trimethoxybenzene, 1,2,4,5-tetramethoxybenzene, and the like, and mixtures thereof. Suitable urea electron donor compounds include N,N′-dimethylurea, N,N-dimethylurea, N,N′-diphenylurea, tetramethylthiourea, tetraethylthiourea, tetra-n-butylthiourea, N,N-di-n-butylthiourea, N,N′-di-n-butylthiourea, N,N-diphenylthiourea, N,N′-diphenyl-N,N′-diethylthiourea, and the like, and mixtures thereof.

Preferred electron donor compounds for free radical-induced reactions include amines that contain one or more julolidinyl moieties, alkylarylborate salts, and salts of aromatic sulfinic acids. However, for such reactions, the electron donor compound can also be omitted, if desired (for example, to improve the shelf stability of the photoreactive composition or to modify resolution, contrast, and reciprocity). Preferred electron donor compounds for acid-induced reactions include 4-dimethylaminobenzoic acid, ethyl 4-dimethylaminobenzoate, 3-dimethylaminobenzoic acid, 4-dimethylaminobenzoin, 4-dimethylaminobenzaldehyde, 4-dimethylaminobenzonitrile, 4-dimethylaminophenethyl alcohol, and 1,2,4-timethoxybenzene.

Preparation of Multiphoton Curable Composition

The curable and optionally non-curable species, multiphoton photosensitizers, electron donor compounds, and electron acceptors can be prepared by the methods described above or by other methods known in the art, and many are commercially available. These components can be combined under “safe light” conditions using any order and manner of combination (optionally, with stirring or agitation), although it is sometimes preferable (from a shelf life and thermal stability standpoint) to add the electron acceptor last (and after any heating step that is optionally used to facilitate dissolution of other components). Solvent can be used, if desired, provided that the solvent is chosen so as to not react appreciably with the components of the composition. Suitable solvents include, for example, acetone, dichloromethane, and acetonitrile. The reactive species itself can also sometimes serve as a solvent for the other components.

The components of the multiphoton photoinitiator system are present in photochemically effective amounts (as defined above). Generally, the multiphoton curable composition contains from about 5% to about 99.79% by weight of one or more reactive species (preferably, from about 10% to about 95%; more preferably, from about 20% to about 80%); from about 0.01% to about 10% by weight of one or more photosensitizers (preferably, from about 0.1% to about 5%; more preferably, from about 0.2% to about 2%); up to about 10% by weight of one or more electron donor compounds (preferably, from about 0.1% to about 10%; more preferably, from about 0.1% to about 5%); and from about 0.1% to about 10% by weight of one or more electron acceptors (preferably, from about 0.1% to about 5%) based upon the total weight of solids in the composition (that is, the total weight of components other than solvent).

A wide variety of adjuvants can be included in the multiphoton curable compositions, depending upon the desired end use. Suitable adjuvants include solvents, diluents, resins, binders, plasticizers, pigments, dyes, inorganic or organic reinforcing or extending fillers (at preferred amounts of about 10% to 90% by weight based on the total weight of the composition), thixotropic agents, indicators, inhibitors, stabilizers, ultraviolet absorbers, medicaments (for example, leachable fluorides), and the like. The amounts and types of such adjuvants and their manner of addition to the compositions will be familiar to those skilled in the art.

It is within the scope of this invention to include nonreactive polymeric binders in the compositions in order, for example, to control viscosity and to provide film-forming properties. Such polymeric binders can generally be chosen to be compatible with the reactive species. For example, polymeric binders that are soluble in the same solvent that is used for the reactive species, and that are free of functional groups that can adversely affect the course of reaction of the reactive species, can be utilized. Binders can be of a molecular weight suitable to achieve desired film-forming properties and solution rheology (for example, molecular weights between about 5,000 and 1,000,000 daltons; preferably between about 10,000 and 500,000 daltons; more preferably, between about 15,000 and 250,000 daltons). Suitable polymeric binders include, for example, polystyrene, poly(methyl methacrylate), poly(styrene)-co-(acrylonitrile), cellulose acetate butyrate, and the lice. Suitable nonreactive polymeric binders, if present, may be included in the compositions up to 90%; preferably up to 75%; more preferably up to 60% by weight of the total composition.

Prior to exposure, the resulting photoreactive compositions can be applied on a substrate, if desired, by any of a variety of application methods. The compositions may be applied by coating methods such as knife, bar, reverse roll, and knurled roll coating, or by application methods such as dipping, immersion, spraying, brushing, curtain coating and the like. Alternatively, the composition can be applied drop-wise. The substrate can be chosen from a wide variety of films, sheets, and other surfaces, depending upon the particular application and the method of exposure to be utilized.

### EXAMPLES

### Preparatory Example 1

Synthesis of Multiphoton Photosensitizer (MPS 1) Reaction of 1,4-bis(bromomethyl)-2,5-dimethoxybenzene with Triethyl Phosphite:

1,4-Bis(bromomethyl)-2,5-dimethoxybenzene was prepared according to the literature procedure (Syper et al, Tetrahedron, 39, 781-792, 1983). The 1,4-bis(bromomethyl)-2,5-dimethoxybenzene (253 g, 0.78 mol) was placed into a 1000 mL round bottom flask. Triethyl phosphite (300 g, 2.10 mol) was added, and the reaction was heated to vigorous reflux with stirring for 48 hours under nitrogen atmosphere. The reaction mixture was cooled and the excess triethyl phosphite was removed under vacuum using a Kugelrohr apparatus. Upon heating to 100 C. at 0.1 mm Hg, a clear oil resulted. Upon cooling, the desired product solidified and was suitable for use directly in the next step. The ¹H NMR spectrum of the product was consistent with the desired product. Recrystallization from toluene yielded colorless needles.

Synthesis of 1,4-bis-[4-(diphenylamino)styryl]-2,5-(dimethoxy) Benzene:

A 1000 mL round bottom flask was fitted with a calibrated dropping funnel and a magnetic stirrer. The flask was charged with the product prepared from the above reaction (19.8 g, 45.2 mmol) and N,N-diphenylamino-p-benzaldehyde (25 g, 91.5 mmol, available from Fluka Chemical Corp., Milwaukee, Wis.). The flask was flushed with nitrogen and sealed with septa. Anhydrous tetrahydrofuran (750 mL) was cannulated into the flask and all solids dissolved. The dropping funnel was charged with potassium tertiary butoxide (125 mL, 1.0 M in THF). The solution in the flask was stirred, and the potassium tertiary butoxide solution was added to the contents of the flask over the course of 30 minutes. The solution was then left to stir at ambient temperature overnight. The reaction was then quenched by the addition of water (500 mL). Stirring was continued, and after about 30 minutes a highly fluorescent yellow solid had formed in the flask. The solid was isolated by filtration, air-dried, and then recrystallized from toluene (450 mL). The desired product was obtained as fluorescent needles (24.7 g, 81% yield). The ¹H NMR spectrum of the product was consistent with the proposed structure.

### Example 2

Reflective Diffraction Grating

A multiphoton curable composition was prepared as follows. A stock solution was prepared by adding 30 g PMMA (Aldrich) to 120 g dioxane, and mixing overnight on a roller. A second solution was prepared by adding 1 g of MPS I to 35 g Sartomer SR9008, then heating and stirring to partially dissolve the photosensitizer. The second solution was added to the stock solution and allowed to mix overnight on a roller. To this solution was added 35 g Sartomer SR368 and the solution allowed to mix overnight on a roller, providing masterbatch B. 0.1 g diaryliodonium hexafluoroantimonate (SR1012, Sartomer) and 0.1 g alkyltriarylborate salt (CGI 7460, Ciba Specialties) was dissolved in 1 ml of acetonitrile and added to the fourth vial containing 11 g of masterbatch B and the solution mixed by agitation.

The multiphoton curable composition, diluted to about 4 weight % solids, was coated onto an aluminized silicon mirror using drops from a syringe to form discrete islands. These islands were then dried for 10 min at 80° C. in an air oven to form films extending over areas a few mm in diameter.

The laser, a Spectra-Physics, Inc., (1335 Terra Bella Avenue, Mountain View, Calif. 94043 USA) “Mai Tai” model, was operated at a wavelength λ=800 nm, a repetition frequency of 80 MHz, and a pulse width of about 100 femtoseconds (1×10⁻¹³ sec). A 40× microscope objective, with focal length of 4.48 mm and numerical aperture of 0.65, was used to focus the laser beam at the surface of the aluminized mirror after passing through the dried resin film. The grating pattern was produced by moving the completed aluminized mirror under the fixed laser beam to draw a series of equally spaced lines. New England Affiliated Technologies (NEAT), Inc., (Lawrence, Mass.) type 310 translation stages were mounted in a crossed configuration to allow scanning in 2 orthogonal directions, each of which was orthogonal to the laser beam. The mirror was mounted on the translation stage assembly and scanned under the laser beam to polymerize the resin by means of the 2-photon interaction, forming a series of parallel lines of polymerized resin with a period of about 19.1 micrometers

The resin pattern was developed by rinsing first in dimethylformamide (DMF), to remove unexposed resin, and second, in isopropyl alcohol, to remove remaining residues. The mirrors were then dried with a stream of nitrogen. The polymerized resin lines interrupt the continuous mirror surface, forming a reflective diffraction grating. Thus a diffraction grating can be added to an already-fabricated mirror with little additional processing.

The grating area can be of any size up to that of the entire mirror, and can be added in any location or orientation by choice of mounting location and stage control program content. The organic solvents used to develop the polymerized pattern are not corrosive, so there is no chance of chemically damaging the exposed aluminum thin film used for the reflective surface. No aluminum etching is required. The drying temperature is too low to cause significant oxidation, and could be reduced substantially, if required, by extending the drying time.

The width of the resin lines depends on laser beam intensity, speed of motion of the focal point with respect to the mirror surface, and the location of the focal point relative to the surface of the mirror. In these examples the mirror was mounted on a pair of NEAT, Inc., type 310 translation stages operated in an x-y configuration in a plane orthogonal to the beam. These stages were used to move the mirror under the stationary laser beam at about 5.08 mm/second. Neutral density filters were used to adjust average beam power to about 13 mW or 50 mW. Scans at 50 mW resulted in line widths of 4.5 to 5.2 micrometers; scans at 13 mW resulted in line widths of about 3.7 micrometers.

The patterns written as described above visually display the iridescent appearance associated with a grating, which spreads white light into a spectrum by bending longer wavelengths to a greater degree than shorter wavelengths. For a given wavelength of light, the angular separation between the optical axis of the beam and different diffraction orders is given by: d sin θ=mλ (Jenkins and White, Fundamentals of Optics, 3^{rd} Edition, McGraw-Hill, New York, 1957, p 331.), where d is the period of the grating, θ is the angle between the optical axis and the diffraction maximum of a given order, m is an integer characterizing the diffraction order, and λ is the wavelength of light used.

A Melles-Griot, Inc. (55 Science Parkway, Rochester, N.Y.), 5 mW, helium-neon laser with a wavelength of λ=632 nm was used to illuminate the grating described above at near-normal incidence. The reflections of the primary beam and the first few diffraction orders were projected onto a white screen located about 71.8 cm from the mirror. For a grating period of 19.1 micrometers, the above formula gives and angle of 1.90° to the first order maximum, and 3.79° to the second order maximum. Measurement on the screen gives the same angles as 1.90° and 3.79°, respectively, demonstrating that a well-behaved diffraction grating has been produced.

### Example 3

Reflective Diffraction Grating on MEMS Scanning Mirror

The same equipment, materials, and techniques described in Example 2, above, have been used to fabricate a reflective diffraction grating on a micro-electromechanical system (EMS) mirror used as an electrically-driven optical scanner. This allows the grating to be rapidly rotated through several degrees, thus scanning the reflected beam back and forth through twice this angle. This could be useful for a variety of optical techniques, among them construction of a rapidly scanned spectrophotometer, where the scanned beam is projected across a slit, with a photocell behind it. As the mirror rotates, the spectrum is swept across the slit. This technique easily allows fabrication of mirrors at frequencies from hundreds of hertz up to tens of kilohertz, allowing for rapid acquisition of spectral data. Typical mirrors used in this example had driving frequencies of from about 10 kHz to about 15 kHz.

The mirror and its base were etched from single crystal silicon using well-known wet anisotropic etching techniques. The mirrors themselves were etched into a thin (0.003″=0.005″) wafer of single crystal silicon, cut with the (100) crystal face exposed. After etching, the square or rectangular mirror was attached to the remaining portion of the wafer only by 2 torsion arms. The surface of the mirror was vacuum-coated with aluminum, for reflectivity and electrical conductivity. The mirror base was similarly etched from a thicker silicon wafer. Here a flat-bottomed cavity was anisotropically wet etched to allow the mirror to pivot on its torsion arms when power was applied. An aluminum electrode was formed on either side of the cavity, running parallel to the torsion arms. The wafer containing the mirror was centered on the cavity, aligned as specified, and bonded to the base with epoxy. Wiring was connected to the 2 base electrodes and the mirror electrode to allow them to be powered. Typically, the mirror was grounded, and the base electrodes alternate between ground and some bias voltage, the biased electrode attracting the grounded mirror toward itself. The bias and ground potentials were switched back and forth between the two electrodes at the resonant frequency of the mirror-torsion arm unit, producing a useful oscillatory amplitude. A simple drive circuit to accomplish this was mounted externally in this example, but could be incorporated almost completely into the silicon, forming an integrated circuit.

Assembled and tested MEMS mirrors described above were coated with 2-photon-sensitized resin as follows: An adhesion promoter, tris(methoxysilyl)methyacrylate (Aldrich), 2 weight % in 95% ethyl alcohol, acidified with acetic acid, was applied 1 drop per mirror, and then dried for 60 minutes at 80° C. in an air oven. The multiphoton curable composition was diluted to 5 weight % solids and was then applied, 1 drop per mirror, and then dried for 10 min at 80° C. in an air oven, to form films.

The laser, a Spectra-Physics, Inc., (1335 Terra Bella Avenue, Mountain View, Calif. 94043, USA) “Mai Tai” model, was operated at a wavelength λ=800 nm, a repetition frequency of 80 MHz, and a pulse width of about 100 femtoseconds (1×10⁻¹³ sec). A 40× microscope objective, with focal length of 4.48 mm and numerical aperture of 0.65, was used to focus the laser beam at the surface of the aluminized mirror after passing through the dried resin film. The grating pattern was produced by moving the completed aluminized mirror under the fixed laser beam to draw a series of equally spaced lines. NEAT, Inc., type 310 translation stages were mounted in a crossed configuration to allow scanning in 2 orthogonal directions, each of which was orthogonal to the laser beam. The mirror was mounted on the translation stage assembly and scanned under the laser beam at 5.08 mm/second to polymerize the resin by means of the 2-photon interaction, forming a series of parallel lines of polymerized resin with a period of 19.1 micrometers.

The resin pattern was developed by rinsing first in propylene-glycol-methyl-ether acetate (Aldrich) to remove unexposed resin, and second, in isopropyl alcohol, to remove remaining residues. Development times of from 30 seconds to 60 seconds were successful. The mirrors were then dried with a stream of nitrogen. The polymerized resin lines interrupt the continuous mirror surface, forming a reflective diffraction grating.

### Example 4

Filling a Cavity

A resin stock solution was prepared by talking 30 grams of PMMA (135K molecular weight) and dissolving it in 120 grams of dichloromethane. An additional 35 grams of Sartomer SR-368 was added along with Sartomer SR-9008.

A second stock solution of initiator components was also made. A two photon dye, bis-[4-(diphenylamino)styryl]-1,4-(dimethoxy)benzene (MPS 1,150 mg), diaryliodonium hexafluoroantimonate (SR-1012, Sartomer, (250 mg)) and organic borate (CGI-7460, Ciga Specialties (250 mg)) was dissolved in a total of 12.35 grams of dichloromethane.

11.0 grams of the resin stock was combined with 1.5 grams of the initiator component solution in order to provide a polymerizable solution. A two-piece mold of steel and PTFE was prepared by drilling 5 holes, 1 mm diameter, 2 mm depth, ⅔ of the hole in the steel, ⅓ in PTFE. The cavities were first loaded with the solution to be polymerized by filling the cavity partially with the uncured resin solution using a 25 microliter syringe, and the solvent was allowed to evaporate for 30 minutes. The process was then repeated until the cavity is completely filled with the unpolymerized resin.

One of the cavities filled with unpolymerized resin was then irradiated using as a light source a diode-pumped Ti-sapphire laser operating at 100 MHz, 100 femtosecond pulses, 800 nm, average light intensity 109 mW, focussed using a filled 10× objective (numerical aperture of 0.25). The uncured resin was cured by placing the focal point of the laser beam at the interface between the unpolymerized resin and the bottom of the cavity, and scanning the focal point in 240 lines 1.2 mm long, spaced 5 μm apart, generating a 1.2 mm square pattern. The 1.2 mm square pattern was repeatedly scanned, moving the focal point 40 μm further away from the bottom of the cavity with each successive scan, until resin was cured up to about half the depth of the cavity (slightly less than 1 mm, Example A). A second cavity filled with uncured resin was cured by placing the focal point of the laser beam at the interface between the unpolymerized resin and air (the top of the cavity). A 1.2 mm square pattern repeatedly scanned with the focused laser as before, moving the focal point about 40 μm closer to the bottom of the cavity with each successive scan, until resin was cured all the way to the bottom of the cavity (Example B). The resulting article containing cavities with partially cured resin was immersed in dimethylformamide for 2 hours to remove any unreacted resin. After rinsing with isopropyl alcohol and dried, the mold was disassembled, and the height and width of the resulting plug (height measured along the axis of the cylindrical cavity) was measured under a microscope (see table below), showing that the cavity irradiated from the bottom up was cured in the bottom half but not the top, and the cavity irradiated top to bottom was cured through the full depth of the cavity.

Examples C, D, E, F (Comparative). A second mold was filled with curable resin as above. For comparison, curable resin in four cavities were irradiated using a He-Cd laser operating continuously at 442 nm (within the 1-photon absorption band of the multiphoton photosensitizer), 2 mW, beam diameter 3 mm, such that each curable resin-filled cavity received twice the dose of the previous curable resin-filled cavity, starting at 71 mJ/cm² and running to 566 J/cm². The resulting article containing cavities with partially cured resin were immersed in dimethylformamide for 2 hours to remove any unreacted resin. After rinsing with isopropyl alcohol and dried, the mold was disassembled, and the height and width of each plug (height measured along the axis of the cylindrical cavity) was measured under a microscope (see table below). The data shows that the comparative examples cured only from the top down, and that curing the resin in the bottom cavity occurs only after resin closer to the light source is cured first.

| Example | Curing method | Dose (mJ/cm²) | Height (μm) | Width (μm) |
|---|---|---|---|---|
| A | Multiphoton, | | 710 (from bottom | 1002 |
| | bottom to top | | | |
| B | Multiphoton, top to | | 1403 | 985 |
| | bottom | | | |
| C | 1 photon | 71 | 830 (from top) | 1409 |
| (Comparative) | | | | |
| D | 1 photon | 142 | 906 (from top) | 1700 |
| (Comparative) | | | | |
| E | 1 photon | 283 | 1568 | 838 |
| (Comparative) | | | | |
| F | 1 photon | 566 | 1620 | 1329 |
| (Comparative) | | | | |

A number of embodiments of the invention have been described. Nevertheless, it will be understood that various modifications may be made without departing from the spirit and scope of the invention. Accordingly, other embodiments are within the scope of the following claims.

What is claimed is:

1. A method for making a structure, comprising:
(a) applying a multiphoton-curable composition to a molded article, wherein the composition comprises a curable species and a multiphoton photoinitiator system;
(b) at least partially curing the multiphoton-curable composition to form a structure on the article.

2. The method of claim 1, further comprising removing uncured multiphoton-curable composition from the article.

3. The method of claim 1, wherein the multiphoton photoinitiator system comprises a multiphoton photosensitizer and an electron acceptor.

4. The method of claim 3, wherein the system further comprises an electron donor.

5. The method of claim 3, wherein the multiphoton photosensitizer has a two-photon absorption cross-section greater than that of fluorescein.

6. The method of claim 3, wherein the multiphoton photosensitizer has a two-photon absorption cross-section at least 1.5 times greater than that of fluorescein.

7. The method of claim 3, wherein the photosensitizer is capable of sensitizing 2-methyl-4,6-bis(trichloromethyl)-s-triazine under continuous irradiation in a wavelength range that overlaps the single photon absorption spectrum of the photosensitizer using the test procedure described in U.S. Pat. No. 3,729,313.

8. The method of claim 3, wherein the multiphoton photosensitizer is selected from Rhodamine B and (a) molecules in which two donors are connected to a conjugated π-electron bridge; (b) molecules in which two donors are connected to a conjugated π-electron bridge which is substituted with one or more electron accepting groups; (c) molecules in which two acceptors are connected to a conjugated π-electron bridge; and (d) molecules in which two acceptors are connected to a conjugated π-electron bridge which is substituted with one or more electron donating groups.

9. The method of claim 3, wherein the multiphoton photosensitizer is Rhodamine B.

10. The method of claim 1, wherein the curable species is selected from the group consisting of acrylates, methacrylates, styrenes, epoxies, vinyl ethers, cyanate esters, and mixtures thereof.

11. The method of claim 1, wherein the curable species comprises an epoxy.

12. The method of claim 1, wherein the composition further comprises a chemically-amplified photoresist.

13. The method of claim 3, wherein the electron acceptor is selected from the group consisting of iodonium salts, chloromethylated triazines, diazonium salts, sulfonium salts, azinium salts, triarylimidazolyl dimers, and mixtures thereof.

14. The method of claim 4, wherein the electron donor compounds are selected from the group consisting of amines, amides, ethers, ureas, sulfinic acids and their salts, salts of ferrocyanide, ascorbic acid and its salts, dithiocarbamic acid and its salts, ferrocene, salts of xanthates, salts of ethylene diamine tetraacetic acid, salts of (alkyl)ₙ(aryl)ₘborates (n+m=4), SnR₄ compounds, where each R is alkyl, aralkyl, aryl, or alkaryl, and mixtures thereof.

15. The method of claim 1, wherein the molded article comprises a surface with at least one feature, and wherein the composition is applied in the feature.

16. The method of claim 15, wherein the feature is microscopic.

17. A method of adding a structure to an article, wherein the article has a surface with at least one microscopic feature, the method comprising:
(a) applying a multiphoton-curable composition to the feature, wherein the composition comprises:
(1) a curable species, and
(2) a multiphoton photoinitiator system comprising a multiphoton photosensitizer and an electron acceptor;
(b) at least partially curing the multiphoton-curable composition to form a structure.

18. The method of claim 17 wherein the structure formed is a microstructure.

19. The method of claim 17, further comprising removing uncured multiphoton-curable composition from the article.

20. The method of claim 17, wherein the system further comprises an electron donor.

21. The method of claim 17, wherein the multiphoton photosensitizer has a two-photon absorption cross-section greater than that of fluorescein.

22. The method of claim 17, wherein the multiphoton photosensitizer has a two-photon absorption cross-section at least 1.5 times greater than that of fluorescein.

23. The method of claim 17, wherein the multiphoton photosensitizer is capable of sensitizing 2-methyl-4,6-bis(trichloromethyl)-s-triazine under continuous irradiation in a wavelength range that overlaps the single photon absorption spectrum of the multiphoton photosensitizer using the test procedure described in U.S. Pat. No. 3,729,313.

24. The method of claim 17, wherein the multiphoton photosensitizers are selected from Rhodamine B and (a) molecules in which two donors are connected to a conjugated π-electron bridge; (b) molecules in which two donors are connected to a conjugated π-electron bridge which is substituted with one or more electron accepting groups; (c) molecules in which two acceptors are connected to a conjugated π-electron bridge; and (d) molecules in which two acceptors are connected to a conjugated π-electron bridge which is substituted with one or more electron donating groups.

25. The method of claim 17, wherein the multiphoton photosensitizer is Rhodamine B.

26. The method of claim 17, wherein the curable species is selected from the group consisting of acrylates, methacrylates, styrenes, epoxies, vinyl ethers, cyanate esters, and mixtures thereof.

27. The method of claim 17, wherein the curable species comprises an epoxy.

28. The method of claim 17, wherein the composition further comprises a non-curable species selected from the group consisting of chemically-amplified photoresists.

29. The method of claim 17, wherein the electron acceptor is selected from the group consisting of iodonium salts, chloromethylated triazines, diazonium salts, sulfonium salts, azinium salts, triarylimidazolyl dimers, and mixtures thereof.

30. The method of claim 20, wherein the electron donor compounds are selected from the group consisting of amines, amides, ethers, ureas, sulfinic acids and their salts, salts of ferrocyanide, ascorbic acid and its salts, dithiocarbamic acid and its salts, ferrocene, salts of xanthates, salts of ethylene diamine tetraacetic acid, salts of (alkyl)ₙ(aryl)ₘborates (n+m=4), SnR₄ compounds, where each R is independently chosen from among alkyl, aralkyl, aryl, and alkaryl, and mixtures thereof.

31. The method of claim 17, wherein the feature is selected from the group consisting of a channel, a post, and a cavity.

32. The method of claim 17, wherein the structure is selected from the group consisting of a valve, a gear, a sphere, a cover, a cap, a cantilever, and a lens.

33. The method of claim 17, wherein the structure is flow control device.

34. A method of adding a structure to an optical fiber, the method comprising:
(a) applying a multiphoton-curable composition to the optical fiber, wherein the composition comprises:
(1) a curable species, and
(2) a multiphoton photoinitiator system comprising a multiphoton photosensitizer and an electron acceptor;
(b) at least partially curing the multiphoton-curable composition to form a structure.

35. The method of claim 34 wherein the structure is at least one optical device selected from the group consisting of a lens, a prism, a diffuser, and a diffractive optical element.

36. A method for making a diffraction grating on a substrate, comprising
applying a multiphoton-curable composition on the surface, wherein the composition comprises:
a curable species, and
a multiphoton photoinitiator system comprising a multiphoton photosensitizer and an electron acceptor; and
at least partially curing the multiphoton-curable composition to form a diffraction grating on the surface.

37. The method of claim 36, further comprising removing uncured composition from the surface.

38. A method of filling a cavity with a multiphotoncured material comprising
providing a multiphoton curable composition, wherein the composition comprises a curable species and a multiphoton photoinitiator system, said multiphoton photoinitiator system comprising a multiphoton photosensitizer and an electron acceptor;
providing a substrate with a cavity;
exposing the multiphoton curable composition to a light source sufficient to cause multiphoton absorption.

39. The method of claim 38 wherein the light source is focused at the interface between a surface of the substrate and a portion of the curable composition.

40. The method of claim 38 further comprising:
adding additional multiphoton curable composition; and
exposing the multiphoton curable composition to a light source sufficient to cause multiphoton absorption.

41. The method of claim 38 further comprising:
repeating the adding and exposing steps.

42. A method of repairing a tooth, comprising:
applying a multiphoton-curable composition to the tooth, wherein the composition comprises:
a curable species, and
a multiphoton photoinitiator system comprising a multiphoton photosensitizer and an electron acceptor;
at least partially curing the multiphoton-curable composition.

43. The method of claim 42, further comprising removing uncured multiphoton-curable composition from the tooth.

44. The method of claim 42 further comprising a non-curable species.
